(19) United States
(12) Patent Application Publication
(10) Pub. No.: US 2026/0237925 A1
(43) Pub. Date: Aug. 13, 2026

(54) HIGH SPEED, HIGH DENSITY CONNECTOR

(71) Applicant: FCI USA LLC, Etters, PA (US)

(72) Inventors: Steven Anthony Blasko, III, New Cumberland, PA (US); Scott Patrick Carbaugh, Orbisonia, PA (US); Raheeq Hasan Anees Darweesh, Mechanicsburg, PA (US); Mark R. Gray, York, PA (US); William Lamar Herb, Harrisburg, PA (US); Gregory A. Hull, York, PA (US); Mark E. Lauermann, Harrisburg, PA (US); Steven E. Minich, York, PA (US); Benjamin Reed Staudt, Harrisburg, PA (US); William Edward Tanis, III, Mechanicsburg, PA (US)

(73) Assignee: FCI USA LLC, Etters, PA (US)

(21) Appl. No.: 19/530,731

(22) Filed: Feb. 5, 2026

Related U.S. Application Data
(60) Provisional application No. 63/756,018, filed on Feb. 7, 2025.

(51) Int. Cl. H01R 12/72; H01R 4/02; H01R 12/77; H01R 13/24; H01R 13/6581; H01R 13/6597

(52) U.S. Cl. CPC H01R 12/721; H01R 4/029; H01R 12/77; H01R 13/24; H01R 13/6581; H01R 13/6597; H01R 2201/04

(57) ABSTRACT

Electrical connectors for high speed signals, including signals at or above 224 Gbps. Effectiveness of shielding along signal paths through mating connectors may be enhanced through using one or more techniques, including enabling shielding around signal pairs from front segments to tail segments, and connections between outer shields of mating connectors. Such techniques may be simply and reliably implemented at high density connector using one or more techniques. An electrical connector can include ground conductors disposed between alternating signal pairs configured for balancing mating forces, outer shields, and selectively positioned lossy material connecting the ground conductors and outer shields. The outer shields of a receptacle connector can include corrugated sheets at the tail segments and front segments. The outer shields of a header connector can include corrugated sheets at the tail segments and beams at the front segments and configured to contact the corrugated sheets at the receptacle front segments.

### CROSS-REFERENCE TO RELATED APPLICATIONS

This application claims priority to and the benefit under 35 U.S.C. § 119(e) of U.S. Provisional Patent Application Ser. No. 63/756,018, filed on Feb. 7, 2025, entitled “HIGH SPEED, HIGH DENSITY CONNECTOR,” which is incorporated herein by reference in its entirety.

### FIELD

This patent application relates generally to interconnection systems, such as those including electrical connectors, used to interconnect electronic assemblies.

### BACKGROUND

Electronic systems are often assembled from multiple subassemblies. The construction and function of the subassemblies varies based on the function of the electronic system. A system, for example, may have subassemblies for processing data, storing data, or communicating data over a network.

Sometimes the subassemblies are joined with electrical connectors. The connectors provide a separable interface such that the subassemblies can be manufactured at different times or in different locations, yet simply assembled into a system. A known arrangement for joining multiple subassemblies is to have one subassembly serve as a backplane. The backplane provides connections between other subassemblies. The backplane may be at the back of an equipment rack with connectors facing into the rack such that when other subassemblies are inserted into the rack connectors on those subassemblies may mate with the connectors on the backplane.

In some systems, a backplane is manufactured as a printed circuit board onto which connectors are mounted. Conducting traces in the backplane electrically connect to signal conductors in the connectors so that signals may be routed between the connectors.

In other systems, connectors of the backplane may be held in a cartridge that provides mechanical support with electrical connections made by cables interconnecting the connectors. Such a configuration, sometimes referred to as a cabled backplane, may be used for high data rates or for large systems that require relatively long signal paths through the backplane to interconnect subassemblies. In comparison to traces within a printed circuit board, cables provide signal paths with high signal integrity, particularly for high frequency signals, such as those above 40 Gbps using an NRZ or PAM4 protocol.

Regardless of how the backplane is formed, connections between the backplane and subassemblies to be connected through the backplane may be made through two-piece connectors. One connector may be on the subassembly with a mating connector in the backplane. Often, the subassemblies are planar printed circuit boards or trays that extend perpendicularly to the major dimension of the backplane. To make connections in this configuration, the connector mounted on the subassembly may have a mounting face and a mating face. The connector may be mounted to the subassembly with the mounting face facing the subassembly. The mating face, for mating with a connector in the backplane, may be at a right angle to the mounting face. With this configuration, conductive elements in the connector on the subassembly may bend through a right angle to make connections between the subassembly and the backplane. In other system configurations, the mating face, for mating with a connector in the backplane, may be parallel to the mounting face. Connectors used in these applications are often called “stacking connectors” or “mezzanine connectors.”

Regardless of the exact application, electrical connector designs have been adapted to mirror trends in the electronics industry. Electronic systems generally have gotten smaller, faster, and functionally more complex. Because of these changes, the number of circuits in a given area of an electronic system, along with the frequencies at which the circuits operate, have increased significantly in recent years. Current systems pass more data between printed circuit boards and require electrical connectors that are electrically capable of handling more data at higher speeds than connectors of even a few years ago.

In a high density, high speed connector, electrical conductors may be so close to each other that there may be electrical interference between adjacent signal conductors. To reduce interference, and to otherwise provide desirable electrical properties, shield members are often placed between or around adjacent signal conductors. The shields may prevent signals carried on one conductor from creating “crosstalk” on another conductor. The shield may also impact the impedance of each conductor, which may further contribute to desirable electrical properties.

Other techniques may be used to control the performance of a connector. For instance, transmitting signals differentially may also reduce crosstalk. Differential signals are carried on a pair of conducting paths, called a “differential pair.” The voltage difference between the conductive paths represents the signal. In general, a differential pair is designed with preferential coupling between the conducting paths of the pair. For example, the two conducting paths of a differential pair may be arranged to run closer to each other than to adjacent signal paths in the connector. No shielding is desired between the conducting paths of the pair, but shielding may be used between differential pairs. Electrical connectors can be designed for differential signals as well as for single-ended signals.

In an interconnection system, connectors are attached to printed circuit boards. Typically a printed circuit board is formed as a multi-layer assembly manufactured from stacks of dielectric sheets, sometimes called “prepreg.” Some or all of the dielectric sheets may have a conductive film on one or both surfaces. Some of the conductive films may be patterned, using lithographic or laser printing techniques, to form conductive traces that are used to make interconnections between circuit boards, circuits and/or circuit elements. Others of the conductive films may be left substantially intact and may act as ground planes or power planes that supply the reference potentials. The dielectric sheets may be formed into an integral board structure by heating and pressing the stacked dielectric sheets together.

To make electrical connections to the conductive traces or ground/power planes, holes may be drilled through the printed circuit board. These holes, or “vias,” are filled or plated with metal such that a via is electrically connected to one or more of the conductive traces or planes through which it passes.

To attach connectors to the printed circuit board, contact “tails” from the connectors may be inserted into the vias or attached to conductive pads on a surface of the printed circuit board that are connected to a via.

### SUMMARY

Aspects of the present disclosure relate to high speed, high density connectors.

Some embodiments relate to a subassembly for an electrical connector. The subassembly may comprise a housing; a plurality of conductive elements held by the housing, each of the plurality of conductive elements comprising a front segment extending out of a first edge of the housing, a tail segment extending out of a second edge of the housing and configured to mount to a circuit board, and an intermediate portion between the front segment and the tail segment; and first and second corrugated sheets disposed on opposite sides of the tail segments of the plurality of conductive elements, each of the first and second corrugated sheets comprising a plurality of valleys overlapping with the tail segments of selected conductive elements of the plurality of conductive elements, a plurality of plateaus each disposed between adjacent valleys of the plurality of valleys, and a plurality of bridges each connecting an adjacent plateau and valley.

Optionally, the subassembly comprises first and second conductive sheets disposed on opposite sides of the housing and comprising tabs extending beyond the second edges of the housing, wherein: the tabs of the first conductive sheet at least partially overlaps with respective plateaus of the plurality of plateaus of the first corrugated sheet; and the tabs of the second conductive sheet at least partially overlaps with respective plateaus of the plurality of plateaus of the second corrugated sheet.

Optionally, the subassembly comprises a plurality of lossy portions, each lossy portion extending through the tail segment of a respective selected conductive element and valleys of the first and second corrugated sheets overlapping with the tail segment of the respective selected conductive element.

Optionally, the selected conductive elements of the plurality of conductive elements comprise slots extending along the intermediate portions of the selected conductive elements, ends of the slots extending into the tail segments of the selected conductive elements; a lossy portion of the plurality of lossy portions extends in the slot of the respective selected conductive element; and the valleys of the first and second corrugated sheets overlapping with the tail segment of the respective selected conductive element comprise recesses that receive the end of the lossy portion.

Optionally, the housing comprises a plurality of protrusions extending from the second edge and into spaces between the plateaus of the first and second corrugated sheets and the tail segments of the plurality of conductive elements, each protrusion having a profile conforming to a plateau and bridges connecting the plateau to respective valleys.

Optionally, the profile is an isosceles trapezoid.

Optionally, the plurality of valleys of the first and second corrugated sheets are welded to the tail segments of the selected conductive elements of the plurality of conductive elements.

Optionally, the tabs of the first conductive sheet are welded to the respective plateaus of the plurality of plateaus of the first corrugated sheet; and the tabs of the second conductive sheet are welded to the respective plateaus of the plurality of plateaus of the second corrugated sheet.

Some embodiments relate to an electrical connector configured for mounting to a circuit board when pressed in a mounting direction towards the circuit board. The electrical connector may comprise a plurality of conductive elements, each of the plurality of conductive elements comprising a front segment, a tail segment, and an intermediate portion between the front segment and the tail segment, wherein: the tail segment of each of the plurality of conductive elements comprises a shaft and at least one beam extending from an edge of the shaft, the at least one beam is configured to press against a wall of a via in the circuit board when the electrical connector is mounted to the circuit board with the edge of the shaft facing the circuit board in the mounting direction, and the edge of the shaft has a profile with a first portion and a second portion, the at least one beam extending from the first portion, and the second portion of the edge extending further in the mounting direction than the first portion.

Optionally, the first portion of the profile of the edge of the shaft curves in a direction opposite to the mounting direction.

Optionally, the electrical connector comprises a corrugated sheet disposed on a side of the tail segments of the plurality of conductive elements, the corrugated sheets comprising a plurality of valleys overlapping with the tail segments of selected conductive elements of the plurality of conductive elements, a plurality of plateaus each disposed between adjacent valleys of the plurality of valleys, and a plurality of bridges each connecting an adjacent plateau and valley, wherein an edge of the corrugated sheet is spaced from the edges of the shafts of the tail segments by a distance in a range of 0.05 mm to 0.15 mm.

Optionally, the electrical connector comprises a conductive sheet comprising a plurality of tabs each overlapping a respective plateau of the plurality of plateaus of the corrugated sheet.

Some embodiments relate to a subassembly for an electrical connector. The subassembly may comprise a housing; and a plurality of conductive elements held by the housing, each of the plurality of conductive elements comprising a front segment comprising a mating contact surface, a tail segment, and an intermediate portion between the front segment and the tail segment, the plurality of conductive elements comprising first conductive elements and second conductive elements, wherein: the mating contact surfaces of the first conductive elements and the mating contact surfaces of the second conductive elements face opposite directions such that complementary conductive elements of a mating connector make contact with the first conductive elements and second conductive elements from opposite sides; and the housing comprises a plurality of extensions adjacent respective first conductive elements and second conductive elements, with the extensions on sides of the respective first conductive elements and second conductive elements opposite the mating contact surfaces.

Optionally, the mating contact surfaces of the first conductive elements are aligned in a first plane; and the mating contact surfaces of the second conductive elements are aligned in a second plane parallel to the first plane.

Optionally, the first conductive elements are disposed in pairs; and the second conductive elements are disposed in pairs and between adjacent pairs of first conductive elements.

Optionally, the plurality of conductive elements are a plurality of first-type conductive elements; and the subassembly comprises a plurality of second-type conductive elements disposed between an adjacent pair of first conductive elements and pair of second conductive elements of the first-type.

Optionally, the plurality of first-type conductive elements extend beyond the plurality of second-type conductive elements in a mating direction; and the subassembly comprises a shielding member contacting the plurality of second-type conductive elements and configured to make contact with a complementary shielding member of a mating connector.

Optionally, the housing comprises a body at least partially enclosing the intermediate portions of the plurality of conductive elements; and the plurality of extensions comprise a plurality of first extensions extending from an edge of the body and configured to support the first conductive elements, and a plurality of second extensions extending from the edge of the body and configured to support the second conductive elements.

Optionally, the plurality of first extensions of the housing are disposed opposite to the mating contact surfaces of the first conductive elements; and the plurality of second extensions of the housing are disposed opposite to the mating contact surfaces of the second conductive elements.

Optionally, the first and second extensions of the housing are disposed in alternative.

Some embodiments relate to a shielding member for a connector subassembly. The shielding member may comprise a conductive sheet comprising a first edge; and a corrugated sheet comprising a plurality of plateaus, a plurality of valleys, and a plurality of bridges each joining an adjacent plateau and valley, wherein edges of the plurality of plateaus of the corrugated sheet abut the first edge of the conductive sheet.

Optionally, broadsides of the plurality of plateaus of the corrugated sheet are flush with a broadside of the conductive sheet.

Optionally, the edges of the plurality of plateaus of the corrugated sheet are welded to the first edge of the conductive sheet.

Optionally, the conductive sheet comprises a plurality of groups of holes; and each group of holes of the conductive sheet is aligned with a respective valley of the plurality of valleys of the corrugated sheet such that the group of holes extends along a length of a conductive element of the connector subassembly connected to the respective valley.

Optionally, the conductive sheet comprises a second edge; the corrugated sheet is a first corrugated sheet; the shielding member comprises a second corrugated sheet comprising a plurality of plateaus, a plurality of valleys, and a plurality of bridges joining an adjacent plateau and valley; and the second corrugated sheet is disposed adjacent the second edge of the conductive sheet.

Optionally, the conductive sheet comprises a bend; and the first edge and the second edge are disposed on opposite sides of the bend.

Optionally, the first edge and the second edge are orthogonal to each other.

Optionally, the plurality of valleys of the second corrugated sheet are aligned with the plurality of valleys of the first corrugated sheet.

Optionally, the conductive sheet comprises a plurality of groups of holes; and each group of holes of the conductive sheet is aligned with respective valleys of the first and second corrugated sheets.

Some embodiments relate to a subassembly for an electrical connector. The subassembly may comprise a pair of shielding members described herein; a plurality of conductive elements disposed between the pair of shielding members, each conductive element comprising a front segment connected to respective valleys of the first corrugated sheets of the pair of shielding members, a tail segment connected to respective valleys of the second corrugated sheets of the pair of shielding members, and an intermediate portion between the front segment and the tail segment; and a lossy material extending through the intermediate portions of the plurality of conductive elements and through the plurality of groups of holes of the conductive sheet.

Some embodiments relate to a subassembly for an electrical connector. The subassembly may comprise a plurality of conductive elements, each of the plurality of conductive elements comprising a front segment, a tail segment, and an intermediate portion between the front segment and the tail segment, the front segment comprising a proximal end connected to the intermediate portion, a distal end, and a contact portion between the proximal end and the distal end; and a housing comprising: a body at least partially enclosing the intermediate portions of the plurality of conductive elements, and a plurality of extensions each extending beyond the distal ends of the plurality of conductive elements such the distal ends of the plurality of conductive elements slide against respective extensions during mating.

Optionally, the plurality of extensions of the housing comprise one or more of an abrasion-resistant material, lubricant material, and waxy material.

Optionally, the housing comprises an extending portion of a material different from that of the body; and the extending portion comprises the plurality of extensions.

Optionally, each of the plurality of extensions comprises a protrusion disposed beyond the distal end of a respective conductive element and shaped to protect the distal end of the respective conductive element.

Optionally, the front segment of each of the plurality of conductive elements is supported by a respective extension of the plurality of extensions of the housing at both a first location adjacent to the proximal end of the front segment of the conductive element and a second location adjacent to the distal end of the front segment of the conductive element.

Optionally, the front segment extends downwards from the proximal end toward the respective extension, curves upwards to an apex, and then extends downwards to the respective extension.

Optionally, for each of the plurality of conductive elements, the contact portion is between the first location and second location and curves away from the respective extension.

Optionally, the contact portion comprises a first subportion extending from the first location; a second subportion extending from the second location; and a transitioning subportion between the first subportion and the second subportion such that the second subportion is both narrower and thinner than the first subportion.

Optionally, the first subportion comprises a slot to reduce stiffness of the contact portion.

Optionally, the plurality of conductive elements are a plurality of first-type conductive elements; and the subassembly comprises a plurality of second-type conductive elements extending beyond the distal ends of the plurality of first-type conductive elements.

Some embodiments relate to a subassembly for an electrical connector. The subassembly may comprise a plurality of conductive elements, each of the plurality of conductive elements comprising a front segment, a tail segment, and an intermediate portion between the front segment and the tail segment, the plurality of conductive elements comprising a plurality of first-type conductive elements, and a plurality of second-type conductive elements, each second-type conductive element comprising a slot elongated along the intermediate portion of second-type conductive element; and a lossy material in the elongated slots of the plurality of second-type conductive elements.

Optionally, for each second-type conductive elements, the slot extends along 60% to 100% of a length of the intermediate portion of the second-type conductive element.

Optionally, the second-type conductive elements are wider than the first-type conductive elements.

Optionally, the subassembly comprises a housing holding the intermediate portions of the plurality of conductive elements; and a shielding member disposed on a side of the housing, wherein the lossy material extends to the shielding member.

Optionally, the lossy material extends through the shielding member at a plurality of locations and comprises buttons on an outer side of the shielding member so as to secure the shielding member to the housing.

Optionally, the shielding member contacts the second-type conductive elements at front segments and/or tail segments.

Optionally, one or more first-type conductive elements are disposed between adjacent second-type conductive elements; and the shielding member comprises enclosures around the front segments and/or tail segments of the one or more first-type conductive elements.

Optionally, the subassembly comprises a housing comprising housing portions and gaps therebetween, wherein the lossy material is in the gaps.

Optionally, each housing portion at least partially encloses the intermediate portions of one or more first-type conductive elements; and adjacent housing portions and respective lossy material together at least partially enclose the intermediate portion of a respective second-type conductive elements.

Some embodiments relate to a subassembly for an electrical connector. The subassembly may comprise a housing; a plurality of conductive elements held by the housing, each of the plurality of conductive elements comprising a front segment extending out of a first edge of the housing, a tail segment extending out of a second edge of the housing, and an intermediate portion between the front segment and the tail segment; and a corrugated sheet disposed on the front segments of the plurality of conductive elements, the corrugated sheet comprising a plurality of valleys joined with the front segments of selected conductive elements of the plurality of conductive elements, a plurality of plateaus each disposed between adjacent valleys of the plurality of valleys, and a plurality of bridges each connecting an adjacent plateaus and valley, wherein the plurality of plateaus extend beyond the plurality of valleys in a mating direction.

Optionally, the front segments of the selected conductive elements extend beyond respective valleys of the plurality of valleys in a mating direction.

Optionally, the corrugated sheet has a forward edge facing in the mating direction; and the forward edge is chamfered in the plurality of valleys.

Optionally, the plurality of plateaus are flush with the front segments of the selected conductive elements in a plane perpendicular to the mating direction.

Optionally, the housing comprises a plurality of extensions extending from the first edge and beyond the plurality of plateaus of the corrugated sheet in the mating direction such that the plurality of extensions provide a hard stop for a mating connector.

Some embodiments relate to a shielding member for a connector subassembly. The shielding member may comprise a first conductive sheet extending in a first plane; a plurality of first beams extending from the first conductive sheet, wherein: each first beam jogs away from the first plane to a second plane and then jogs away from the second plane to a third plane disposed between the first plane and the second plane; and each first beam comprises a first contact portion on the second plane and configured to contact a ground conductor of the connector subassembly, and a second contact portion on the third plane and configured to contact a shielding member of a mating connector.

Optionally, the shielding member comprises a second conductive sheet extending in a fourth plane separated from the third plane by the first plane; and a plurality of second beams extending from the second conductive sheet and configured to contact the shielding member of the mating connector.

Optionally, the first and second conductive sheets are integral with each other.

Optionally, the shielding member comprises a corrugated sheet coupled to the second conductive sheet through the first conductive sheet, the corrugated sheet comprises plateaus connected to the first conductive sheet, valleys disposed between adjacent plateaus, and bridges joining adjacent plateau and valley.

Optionally, the first conductive sheet comprises a plurality of tabs; and the plateaus of the corrugated sheet are welded to respective tabs of the first conductive sheet.

Some embodiments relate to a subassembly for an electrical connector. The subassembly comprises a plurality of conductive elements, each of the plurality of conductive elements comprising a front segment, a tail segment, and an intermediate portion between the front segment and the tail segment, the plurality of conductive elements comprising a plurality of signal conductors, and a plurality of ground conductors wider than the plurality of signal conductors and configured to be indirectly coupled to ground conductors of a mating connector.

Optionally, the subassembly comprises a shielding member disposed on a side of the plurality of conductive elements, the shielding member comprising a plurality of first contact portions contacting respective ground conductors, and a plurality of second contact portions configured to contact ground conductors and/or a shielding member of the mating connector.

Optionally, the shielding member comprise a plurality of beams; and each beam comprises a first contact portion of the plurality of first contact portions at a proximal end, a second contact portion of the plurality of second contact portions adjacent a distal end, and a curved portion joining the first contact portion and second contact portion such that the second contact portion is configured to contact the shielding member of the mating connector.

Optionally, the shielding member comprise a corrugated sheet, the corrugated sheet comprising valleys each corresponding to a respective ground conductor and plateaus each disposed between adjacent valleys and corresponding to one or more signal conductors disposed between adjacent ground conductors; and each valley comprises a first contact portion of the plurality of first contact portions and a second contact portion of the plurality of second contact portions configured to contact a ground conductor of the mating connector.

Some embodiments relate to a shielding member for a cable attachment region of a cable assembly. The shielding member may comprise a hooding portion comprising: a first end configured to abut a rear end of lead assembly of the cable assembly; a second end configured for cables to extend thereout; and a plurality of chambers, each of the plurality of chambers extending from the first end to the second end, each of the plurality of chambers having a first profile at the first end and a second profile at the second end, the second profile conforming to an outer profile of a cable shield so as to contact the cable shield, the first profile different from the second profile.

Optionally, each of the plurality of chambers of the hooding portion comprises a first groove shaped and positioned to receive a tab of a shielding member of the lead assembly of the cable assembly.

Optionally, the hooding portion comprises a plurality of separators between adjacent chambers, each separator comprising a second groove shaped and positioned to receive a contact portion of a shielding member of the lead assembly, the contact portion attached to a respective ground conductor of the lead assembly.

Optionally, ends of lossy portions of the lead assembly extend into respective second grooves.

Optionally, the plurality of chambers are on an inner side of the shielding member; the shielding member comprises a recess on an outer side and a compliant portion disposed in the recess; the hooding portion comprises a plurality of opening extending through the outer side to the inner side; and the compliant portion comprises a plurality of compliant beams extending through respective openings of the plurality of openings into respective chambers of the plurality of chambers so as to contact the cables shields disposed inside the respective chambers.

Some embodiments relate to a subassembly for an electrical connector. The subassembly may comprise a plurality of signal conductive elements, each of the plurality of signal conductive elements comprising a front segment, a tail segment, and an intermediate portion between the front segment and the tail segment, wherein the front segments of the plurality of signal conductive elements are disposed in a row and comprise contact surfaces, with contact surfaces of a first subset of the signal conductive elements facing in a first direction and a second subset of the signal conductive elements facing in a second direction opposite the first direction; a plurality of ground conductive elements, each of the plurality of ground conductive elements comprising a front segment, a tail segment, and an intermediate portion between the front segment and the tail segment, wherein the front segments of the plurality of ground conductive elements are disposed in the row; and a corrugated sheet comprising alternating plateaus and valleys such that the plateaus bound regions between valleys, wherein the valleys are attached to respective front segments of the plurality of ground conductive elements and the front segments of the signal conductive elements are disposed within respective regions bounded by the plateaus.

Optionally, the front segments of the plurality of ground conductive elements are flat.

Optionally, the front segments of the plurality of signal conductive elements comprise compliant beams.

Optionally, the corrugated sheet comprises a first surface and a second surface opposite the first surface; the second surface of the corrugated sheet faces distal ends of the plurality of ground conductive elements; and the corrugated sheet comprises mating contact surfaces on the first surface within the valleys.

Optionally, the corrugated sheet comprises mating contact surfaces on the first surface on the plateaus.

Optionally, the subassembly described herein in combination with a subassembly of a mating connector, wherein the mating contact surfaces of the corrugated sheet comprise plated regions.

Some embodiments relate to a subassembly for an electrical connector. The subassembly may comprise a housing comprising an outer surface; a plurality of conductive elements held by the housing, each of the plurality of conductive elements comprising a front segment extending out of the housing, a tail segment, and an intermediate portion between the front segment and the tail segment, wherein the plurality of conductive elements comprises a plurality of first-type conductive elements and a plurality of type conductive elements; and a conductive sheet held against the outer surface of the housing, the conductive sheet comprising a plurality of beams formed therein, wherein each of the plurality of beams comprises a proximal end, a distal end, a first contact portion attached to a front segment of a respective second-type conductive element, and a second contact portion comprising a mating contact surface.

Optionally, the plurality of conductive elements are held in a first plane and the outer surface of the housing is in a second plane parallel to the first plane.

Optionally, each of the plurality of beams bends in a direction from the second plane towards the first plane.

Optionally, the plurality of beams comprise a plurality of first-type beams and a plurality of second-type beams.

Optionally, the first-type beams are wider than the second-type beams.

Optionally, the first-type beams are longer than the second-type beams.

Optionally, the front segment of each of the first-type conductive elements comprises a blade with a mating contact surface thereon.

Optionally, the front segments of the first-type conductive elements extend from the housing a longer distance than the front segments of the second-type conductive elements.

Optionally, the conductive sheet has a distal edge; the first-type beams extend from the conductive sheet at a first distance from the distal edge; the first-type beams extend towards the distal edge; the second-type beams extend from the conductive sheet at a second distance from the distal edge; and the first distance is greater than the second distance.

Optionally, the conductive sheet comprises a jog, such that the conductive sheet comprises a first sheet and a second sheet; and the first-type beams extend from the first sheet and the second-type beams extend from the second sheet.

Optionally, the first-type conductive elements are signal conductors and the second-type conductive elements are ground conductors.

These techniques may be used alone or in any suitable combination. The foregoing summary is provided by way of illustration and is not intended to be limiting.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a perspective view of an electrical interconnection system, showing lead assemblies of a receptacle connector and a header connector, according to some embodiments.

FIG. 1B is a top view of the electrical interconnection system of FIG. 1A, showing circuit boards the connectors may be mounted to.

FIG. 2A is a top, front perspective view of a lead assembly of the receptacle connector of the electrical interconnection system of FIG. 1A, according to some embodiments.

FIG. 2B is a side view of the lead assembly of FIG. 2A.

FIG. 2C is a front view of a region of the lead assembly of FIG. 2A in a box marked “2C” in FIG. 2A.

FIG. 2D is a rear view of the region of FIG. 2C.

FIG. 3A is a top view of conductive elements of the lead assembly of FIG. 2A.

FIG. 3B is an enlarged perspective view of a region of the conductive elements of FIG. 3A in a box marked “3B” in FIG. 3A, showing a housing of the lead assembly of FIG. 2A.

FIG. 3C is a top view of the region of FIG. 3B, with an extension of the housing hidden and showing blades of a mating connector.

FIG. 3D is an enlarged view of a region of the conductive elements of FIG. 3A in a box marked “3D” in FIG. 3A.

FIG. 4A is a top, front perspective view of a housing of the lead assembly of FIG. 2A.

FIG. 4B is a top, rear perspective view of the housing of FIG. 4A.

FIG. 4C is an exploded perspective view of the housing of FIG. 4A.

FIG. 5 is a top, rear perspective view of a lossy material of the lead assembly of FIG. 2A.

FIG. 6A is a top, front perspective view of a shielding member of the lead assembly of FIG. 2A.

FIG. 6B is a top, rear perspective view of the shielding member of FIG. 6A.

FIG. 7 is a cross-sectional perspective view of the lead assembly of FIG. 2A along a line marked “7-7” in FIG. 2A, with the housing of FIG. 4A hidden.

FIG. 8 is a cross-sectional perspective view of the lead assembly of FIG. 2A along a line marked “8-8” in FIG. 7, with the housing of FIG. 4A hidden.

FIG. 9A is an enlarged perspective view of a region of the lead assembly of FIG. 2A in a box marked “9A” in FIG. 8, with eyes of tail segments of the conductive elements hidden.

FIG. 9B is another perspective view of the region of the lead assembly of FIG. 9A, with a corrugated sheet of the shielding member of FIG. 6A shown in phantom and a conductive sheet of the shielding member of FIG. 6A hidden.

FIG. 10A is a cross-sectional perspective view of the lead assembly of FIG. 2A along the line marked “8-8” in FIG. 7, with the lossy material of FIG. 5 and the shielding member of FIG. 6A hidden.

FIG. 10B is an enlarged view of a region of the lead assembly of FIG. 10A in a box marked “10B” in FIG. 10A.

FIG. 10C is a side view of the region of FIG. 10B.

FIG. 11 is a perspective view of a region of the lead assembly of FIG. 2A in a box marked “11” in FIG. 2A.

FIG. 12A is a perspective view of a lead assembly of the header connector of the electrical interconnection system of FIG. 1A, according to some embodiments.

FIG. 12B is a side view of the lead assembly of FIG. 12A.

FIG. 12C is an enlarged perspective view of a region of the lead assembly of FIG. 12A in a box marked “12C” in FIG. 12A.

FIG. 12D is a front view of the lead assembly of FIG. 12A, with shielding members hidden.

FIG. 13 is a top view of conductive elements of the lead assembly of FIG. 12A.

FIG. 14 is a top, front perspective view of a housing of the lead assembly of FIG. 12A.

FIG. 15 is a top, rear perspective view of a lossy material of the lead assembly of FIG. 12A.

FIG. 16A is a bottom, front perspective view of a shielding member of the lead assembly of FIG. 12A.

FIG. 16B is a side view of the shielding member of FIG. 16A.

FIG. 16C is a top view of the shielding member of FIG. 16A shown in phantom, showing the conductive elements of FIG. 13.

FIG. 17A is an enlarged cross-sectional perspective view of the lead assembly of FIG. 12A along a line marked “17A-17A” in FIG. 12A, showing portions of a mating connector.

FIG. 17B is a perspective view of a mating region between lead assemblies of mating connectors as shown in FIG. 17A, according to an alternative embodiment.

FIG. 18 is an enlarged cross-sectional view of a region of the lead assembly of FIG. 12A along a line marked “18-18” in FIG. 12A, showing portions of a mating connector.

FIG. 19A is a top perspective view of a cable assembly, according to some embodiments.

FIG. 19B is a partially exploded view of the cable assembly of FIG. 19A, with a front portion of a lead assembly cut off to enlarge a cable attachment region of the cable assembly.

FIG. 20A is a top, rear perspective view of the lead assembly of the cable assembly of FIG. 19A, with portions hidden to show conductive elements and a shielding member.

FIG. 20B is a side view of the lead assembly of FIG. 20A.

FIG. 21A is a top, front perspective view of a hooding portion of a shielding member for the cable attachment region of the cable assembly of FIG. 19A.

FIG. 21B is a bottom, front perspective view of the hooding portion of FIG. 21A.

FIG. 21C is a front view of the hooding portion of FIG. 21A.

FIG. 21D is a rear view of the hooding portion of FIG. 21A.

FIG. 22 is a bottom perspective view of a compliant portion of the shielding member for the cable attachment region of the cable assembly of FIG. 19A.

FIG. 23 is a cross-sectional perspective view of the cable assembly of FIG. 19A along a line marked “23” in FIG. 19A.

FIG. 24 is a partial cross-sectional perspective view of the cable assembly of FIG. 19A along a line marked “24” in FIG. 20A.

FIG. 25 is a partial cross-sectional perspective view of the cable assembly of FIG. 19A along a line marked “25” in FIG. 20A.

### DETAILED DESCRIPTION

The inventors have recognized and appreciated techniques that increase performance of high density interconnection systems, particularly those that carry high frequency signals that are necessary to support high data rates. The techniques may provide an electrical connector that is economical to manufacture, using conventional molding processes for the connector housing and stamping processes for the shields, yet be mechanically robust and provide desirable performance at high frequencies to support high data rates, including at 224 Gbps and above, for closely spaced signal conductors of a high density interconnect (e.g., in-column pair pitch of 3.00 mm and a between-column pair stagger of 0.8 mm).

The inventors have recognized and appreciated techniques to incorporate conductive shielding and lossy material to form enclosing structures around signal pairs from front segments to tail segments, which enables operation at high frequencies to support high data rates, for example, at or above 224 Gbps. In some embodiments, a subassembly for an electrical connector may include pairs of signal conductors having front segments arranged in a column, and outer shields disposed on opposite sides of the signal conductors. To effectively isolate adjacent signal pairs, lossy material may be selectively molded between housing portions that hold the signal pairs. For example, ground conductors may be disposed between signal pairs and the lossy material may be molded over the ground conductors. The lossy material may include lossy buttons that both mechanically hold and electrically couple the outer shields to the housing. The lossy buttons may be formed with a heat staking process. Such a configuration may provide enclosing structures for the signal pairs, with two sides of the enclosing structure for each pair formed by the lossy material and two sides formed by the outer shields. The outer shields may include corrugated sheets that extend the enclosing structures to the tail segments and/or front segments of the signal conductors. The lossy material may at least extend into the corrugated sheets at the front segments. The inventors have found that the lossy extensions, though spanning a small distance into the front segments, such as 0.2 mm or less, provides a desirable increase in signal integrity, particularly for high frequency signals. The enclosing structures may be formed with relatively economical manufacturing processes such as molding, assembling, stamping, and heat staking.

The inventors have recognized and appreciated techniques to enhance mechanical strength of a high density interconnect while reducing resonances and increasing the integrity of signals passing through the interconnect. In some embodiments, a subassembly for an electrical connector may include alternating pairs of signal conductors, with adjacent pairs having mating contact surfaces facing opposite sides of the subassembly. Such a configuration may generate more balanced mating forces than a conventional design with all mating contact surfaces facing a same side. The front segments of signal pairs may be supported by housing extensions. For a header connector with blades, the housing extensions may support the backs of the blades to an extent within distal ends of the blades. For a receptacle connector with compliant beams, the housing extensions may extend beyond distal ends of the compliant beams to provide supports at both ends of each beam. The inventors have found that the double-supported beams may reduce the lengths of electrical stubs on both the receptacle and header sides while maintaining necessary elastic range. As the beams may slide against the housing extensions during mating, the housing extensions may include a material that make it more abrasion resistant than the body of the housing.

The inventors have further recognized and appreciated techniques to enable connections between outer shields of mating connectors so as to reduce resonances and increase the integrity of signals passing through the connectors. In some embodiments, the connections between the outer shields of the mating connectors may replace direct connections between ground conductors of the mating connectors. For example, a first connector of the mating connectors may have corrugated sheets at the front segments; and a second connector of the mating connectors may have beams configured to make contact with the corrugated sheets. The beams may include first beams configured to make contact with valleys of the corrugated sheets and second beams configured to make contact with plateaus of the corrugated sheets. Each first beam may have a first contact portion attached to a ground conductor of the second connector and a second contact portion configured to make contact with a valley of the corrugated sheet that attached to a ground conductor of the first connector. The beams may be simply stamped out of the outer shields, enabling economical manufacturing.

Such a configuration may enable sequential mating. During connector mating, the second beams of the outer shield of the second connector may first make contact with the plateaus of the corrugated sheets of the first connector, which can reduce the risk of damage from electrostatic discharge (ESD). Next, the signal conductors of the first and second conductors may mate with each other. Lastly, the first beams of the outer shield of the second connector may make contact with the valleys of the corrugated sheets of the first connector. Such a sequential mating process may reduce mating forces, while reducing the risk of damage from ESD.

The inventors have also recognized and appreciated techniques to reduce resonances and increase the integrity of signals passing through a connector that terminates cables. The techniques may include connecting shields of connector subassemblies to shields of cables that are terminated to the connector subassemblies. The connection may be made through a shielding member at cable attachment regions. The shielding member may include chambers each for the cable attachment region of a signal pair. Each chamber may have a first profile at a first end abutting a rear end of a lead assembly and a second profile at a second end configured for cables to extend thereout. The first profile may mimic the profile provided by corrugated sheets so as to reduce pair-to-pair crosstalk and match impedance control of connectors using corrugated sheets. The second profile may conform to an outer profile of a cable shield so as to contact the cable shield.

These techniques may be used separately or any two or more of these techniques may be used together, to provide desirable electrical characteristics for the interconnection system from the board and/or cables through the connector to another connector, which may similarly be configured for desirable electrical performance at high frequencies.

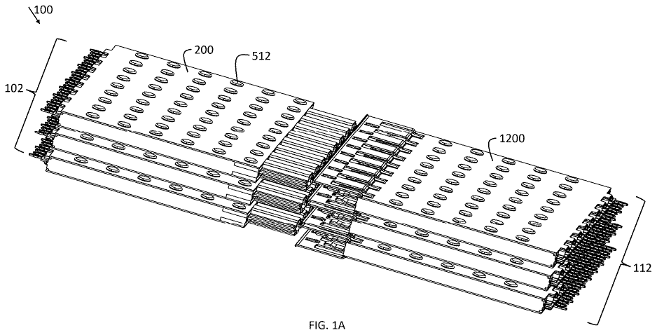

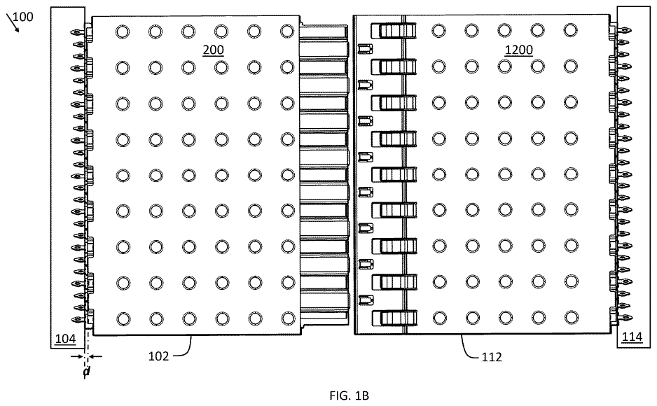

An exemplary embodiment of such connectors is illustrated in FIGS. 1A and 1B. FIGS. 1A and 1B show an electrical interconnection system 100 that may be used in an electronic system. Electrical interconnection system 100 may include two mating connectors, here illustrated as a receptacle connector 102 and a header connector 112. FIG. 1A depicts lead assemblies 200 of the receptacle connector 102 and lead assemblies 1200 of the header connector 112. It should be appreciated that each of the receptacle connector 102 and header connector 112 may include a support, such as a connector housing, configured for receiving respective lead assemblies. A support is not depicted in FIG. 1A and FIG. 1B for simplicity of illustration.

FIG. 1B shows that the receptacle connector 102 may be mounted to a circuit board 104 and the header connector 112 may be mounted to a circuit board 114. It should be appreciated that although the illustrated connectors 102 and 112 are configured such that the circuit boards 104 and 114 extending in parallel planes, the present disclosure may not intend to be limited in this aspect. For example, the connectors may be configured such that the circuit boards extending orthogonally, or in coplanar. As another example, one or both of the connectors may be configured for cable attachments.

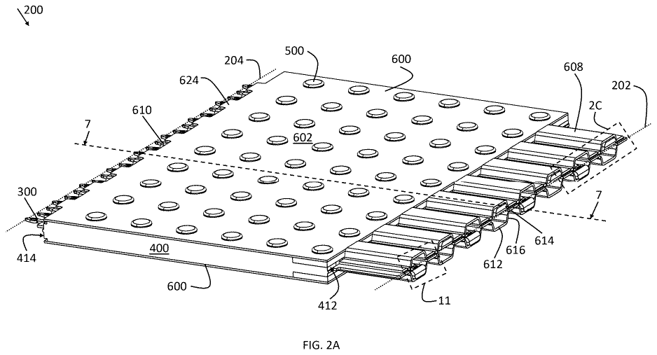

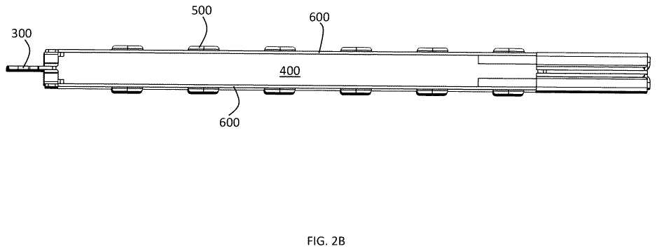

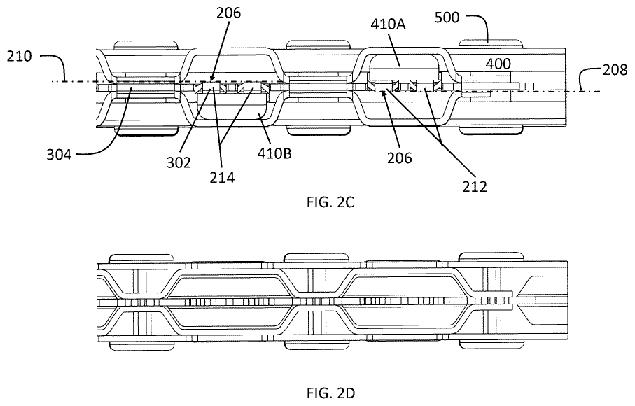

FIGS. 2A-2B show a lead assembly 200 of the receptacle connector 102 of the electrical interconnection system 100, according to some embodiments. FIG. 2C is a front view of a region of the lead assembly 200 in a box marked “2C” in FIG. 2A. FIG. 2D is a rear view of the region 2C. The lead assembly 200 may include conductive elements 300 having front segments disposed in a first column 202 and tail segments disposed in a second column 204. In the illustrated example, the second column 204 is parallel to the first column 202. In other examples such as when the receptacle connector 102 is configured as a right-angle connector, the second column 204 may be orthogonal to the first column 202. The lead assembly 200 may include a housing 400 at least partially holding the conductive elements, shielding members 600 disposed on opposite sides of the conductive elements, and lossy material 500 configured to secure the shielding members 600 in desired positions. In some embodiments, the shielding members 600 may be symmetrical about the conductive elements 300.

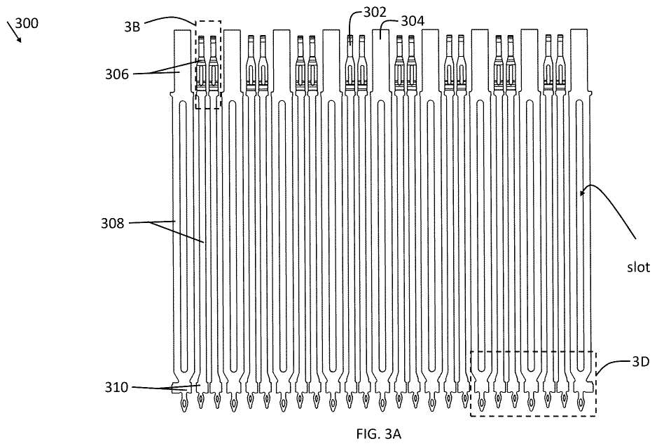

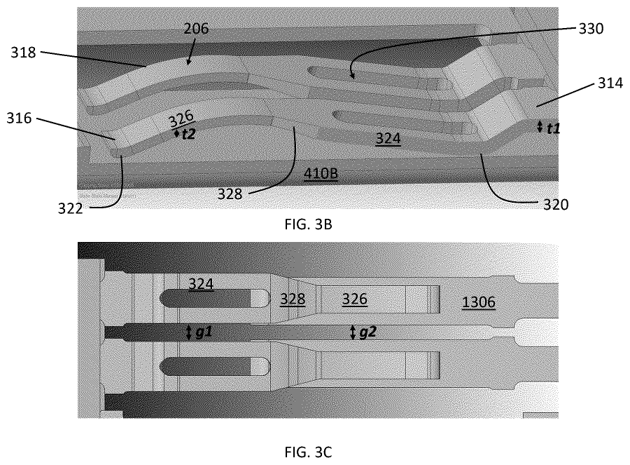

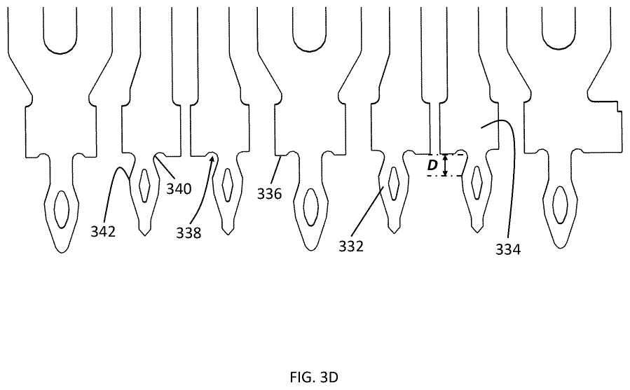

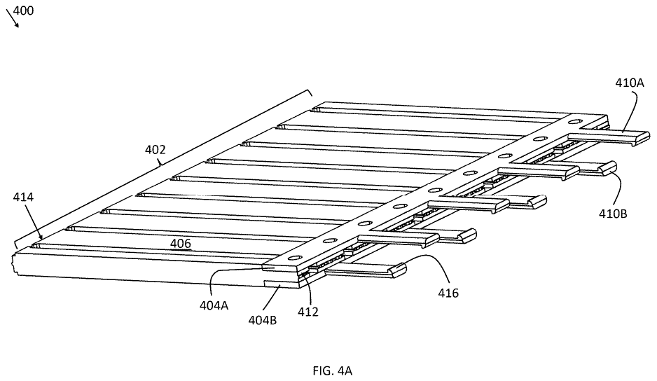

FIG. 3A is a top view of the conductive elements 300 of the lead assembly 200. The conductive elements 300 may include signal conductors 302 and ground conductors 304 disposed between adjacent signal conductors 302. Each conductive element may include a front segment 306, a tail segment 310, and an intermediate portion 308 between the front segment 306 and tail segment 310.

As illustrated, the ground conductors 304 may extend beyond the signal conductors 302 in a mating direction. The ground conductors 304 may be wider than the signal conductors 302 in a direction perpendicular to the mating direction. Each ground conductor 304 may include a slot 312 elongated along the intermediate portion 308 of the ground conductor 304. In some embodiments, the slot may extend along 60% to 100% of a length of the intermediate portion 308 of the ground conductor 304.

The signal conductors 302 may be disposed in pairs between adjacent ground conductors 304. FIG. 3B is an enlarged view of a region of the conductive elements of FIG. 3A in a box marked “3B” in FIG. 3A, showing an extension 410 of the housing 400 of the lead assembly of 200. As illustrated, the front segment 306 of each signal conductor 302 may include a proximal end 314 connected to the intermediate portion 308, a distal end 316, and a contact portion 318 between the proximal end 314 and the distal end 316. When engaging a mating conductor, the front segment 306 of each signal conductor 302 may be supported by the extension 410 of the housing 400 at both a first location 320 adjacent to the proximal end 314 and a second location 322 adjacent to the distal end 316. The inventors have found that the double-supported contact portions 318 may reduce the lengths of electrical stubs on both the receptacle and header sides while maintaining necessary elastic range. As the contact portions 318 may slide against the housing extensions during mating, the housing extensions 410 may include a material that make it more abrasion resistant than the body of the housing. For example, the housing extensions 410 may include one or more of an abrasion-resistant material, lubricant material, and waxy material.

In some embodiments, the contact portion 318 may include a first subportion 324 extending from the first location 320, a second subportion 326 extending from the second location 322, and a transitioning subportion 328 between the first subportion 324 and the second subportion 326 such that the second subportion 326 is both narrower and thinner than the first subportion 324. For example, the first subportion 324 may have a thickness t1 of 1.2 mm, and the second subportion 326 may have a thickness t2 of 0.8 mm. The first subportion 324 may include a slot 330 to reduce stiffness of the contact portion 318. The second subportion 326 may include a mating contact surface 206 configured to make contact with a conductive element of a mating connector.

In some embodiments, signal conductors may be disposed in alternating pairs, with adjacent first and second pairs 212 and 214 having mating contact surfaces facing opposite sides of the lead assembly 200. For example, as illustrated in FIG. 2C, the mating contact surfaces 206 of the first pairs 212 may be aligned in a first plane 208; and the mating contact surfaces 206 of the second pairs 214 may be aligned in a second plane 210 parallel to the first plane 208. The inventors have recognized and appreciated that such a configuration may generate more balanced mating forces than a conventional design with all mating contact surfaces facing a same side, enabling disposing the pairs close to each other to achieve desired high density.

FIG. 3C is a top view of the region 3B, with the extension 410 of the housing 400 hidden and showing blades 1360 of a mating connector. FIG. 3C shows the configuration of the front segments 306 of signal conductors 302 may enable effective impedance control. At the proximal ends 314, the impedance may be controlled by the gap g1 between the first subportions 324 of the front segments 306 of the pair of signal conductors 302. At the distal ends 316, the second subportions 326 are coined to be thinner in the stock-thickness direction and narrower side-to-side such that the impedance is more affected by the gap g2 between the header front segments (shown as blades) 1306. While mating region impedance typically rises substantially when the connectors are partially un-mated or incompletely mated, the configuration described herein can reduce the impedance disruption from partial un-mate or incomplete mating.

FIG. 3D is an enlarged view of a region of the conductive elements of FIG. 3A in a box marked “3D” in FIG. 3A. As illustrated, the tail segment 310 of each conductive element 300 may include a shaft 334 extending from the intermediate portion 308, and a beam 332 extending from an edge of the shaft 334 and configured to press against a wall of a via in a circuit board (e.g., circuit board 104, 114). The edge of the shaft 334 may face the circuit board in the mounting direction. The edge of the shaft 334 may include a profile with a first portion 338 and a second portion 336. A proximal end 340 of the beam 332 may extend from the first portion 338 of the profile and thus above the second potion 336 of the profile. The first portion 338 of the profile may curve in a direction opposite to the mounting direction. The second portion 338 of the profile may enable the reduction of the distance D between the point of contact (e.g., barrels 342) with the via wall and the surface of the circuit board, while enabling the beam 332 to have a length that provides a desired force against the via wall. With the reduction of the distance D, the point of contact may be at locations close to the top of the circuit board, making it possible to add one or more layers within the board for routing high speed signals.

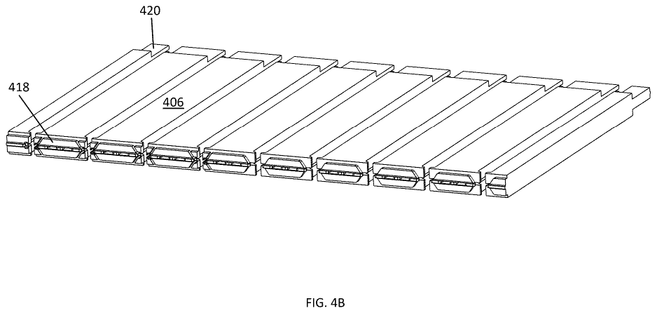

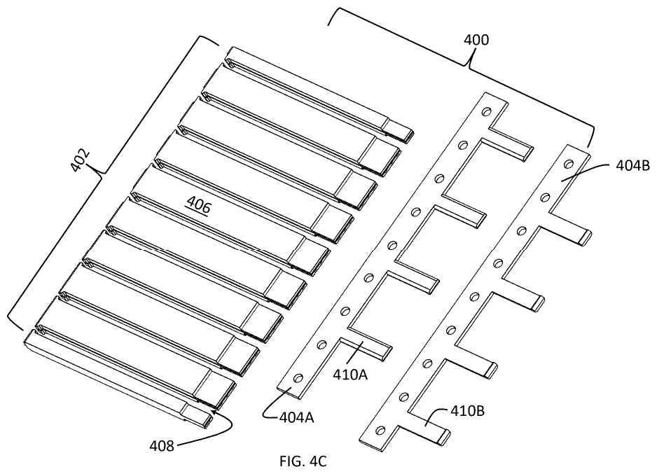

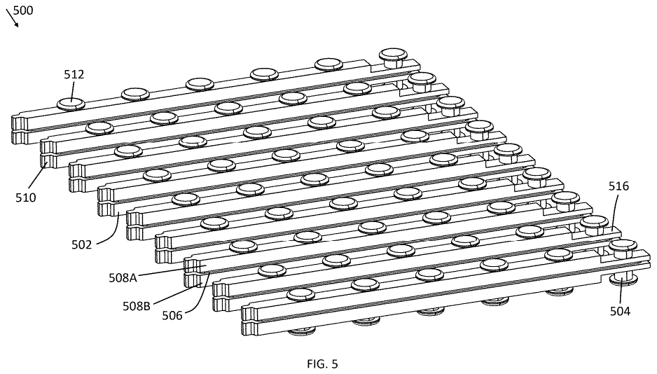

FIGS. 4A and 4B show the housing 400 of the lead assembly 200. FIG. 4C is an exploded perspective view of the housing 400. As illustrated, the housing 400 may include a first edge 412 and a second edge 414. The front segments 306 of the conductive elements 300 may extend out of the first edge 412, and the tail segments 310 of the conductive elements 300 may extend out of the second edge 414. The second edge 414 may include protrusions 418 positioned and shaped to support corrugated sheets of the shielding member 600.

The housing 400 may include a body 402 at least partially enclosing the intermediate portions 308 of the conductive elements 300. The body 402 may include housing portions 406 with gaps 408 therebetween. Each housing portion 406 may at least partially enclose the intermediate portions 308 of one or more signal conductors 302 (e.g., a signal pair).

The body 402 of housing 400 may be made of an insulative material, which may be a dielectric material such as plastic or nylon. Examples of suitable materials include, but are not limited to, liquid crystal polymer (LCP), polyphenylene sulfide (PPS), high temperature nylon or polyphenylene oxide (PPO) or polypropylene (PP). Other suitable materials may be employed, as aspects of the present disclosure are not limited in this regard.

The housing 400 may include top and bottom extending portions 404A and 404B disposed on opposite sides of the body 402. For example, a front portion 420 of the body 402 may be thinned such that the extending portions 404A and 404B are partially disposed in the space created by the thinned portion and flush with the un-thinned portions of the body 402. Referring also to FIG. 2C, the top extending portion 404A may include first extensions 410A extending from the first edge 412 of the body 402 and configured to support the first pairs 212. The bottom extending portion 404B may include second extensions 410B extending from the first edge 412 of the body 402 and configured to support the second pairs 214. The extensions 410A and 410B may include protrusions 416 disposed beyond the distal ends 316 of the signal conductors 302 and shaped to protect the distal ends 316 of the signal conductors 302.

As the contact portions 318 of signal conductors 302 may slide against the first and second extensions 410A and 410B of the extending portions 404A and 404B during mating, the extending portions 404A and 404B may include material different from the material of the body 402 of the housing 400. For example, the extending portions 404A and 404B may include a material that make it more abrasion resistant than the body 402 of the housing 400. For example, the extending portions 404A and 404B may include one or more of an abrasion-resistant material, lubricant material, and waxy material.

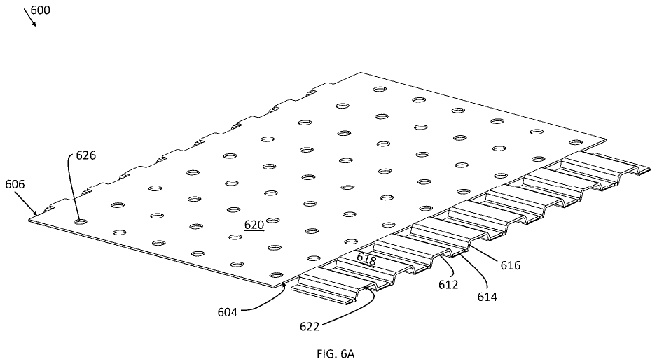

The lossy material 500 may be disposed in the gaps 408 so as to connect the housing portions 406. FIG. 5 is a top, rear perspective view of the lossy material 500 of the lead assembly 200. The lossy material 500 may include lossy portions 502. Each lossy portion 502 may include a first subportion 506 extending in the slot 312 of a respective ground conductor 304, and second and third subportions 508A and 508B extending between the respective ground conductor 304 and the respective one of the top and bottom shielding members 600. The second and third subportions 508A and 508B may include lossy buttons 512, which may be formed after the shielding members 600 are assembled with a heat staking process by heating and/or compressing the lossy material 500 that extends through holes 626 of the shielding members 600. The second and third subportions 508A and 508B may include a front portion 516, which may be thinned like the front portion 420 of the housing portions 406 such that the extending portions 404A and 404B are partially disposed in the space created by the thinned portion and flush with the un-thinned portions of the second and third subportions 508A and 508B. The second and third subportions 508A and 508B may include rear ends 510, which may be narrower than the rest of the subportions and extend beyond the second edge 414 of the housing 400. The lossy portions 502 may include pillars 504 extending through both the extending portions 404A and 404B and the shielding members 600.

It should be appreciated that although the lossy portions 502 are shown as separate from the housing 400, the lossy portions 502 may be integral with the housing 400 and referred to as part of the housing for the lead assembly 200. For example, a method of manufacturing the lead assembly 200 may include providing a lead frame comprising the conductive elements 300, molding the housing portions 406 over the signal conductors 302, molding the lossy portions 502 over the ground conductors 304 and to fill the gaps 408 between the housing portions 406, and molding the extending portions 404A and 404B. The extending portions 404A and 404B may be molded in a shot after the overmolding of the lossy portions 502 such that some regions of the lossy material (e.g., lossy pillars 504, which may be disposed in the front portion 420 of the body 402) are covered by the insulative material of the extending portions 404A and 404B and the insulative material of the extending portions 404A and 404B provides isolation at selected regions.

Any suitable lossy material may be used for the lossy material 500 and other structures that are “lossy.” Materials that dissipate a sufficient portion of the electromagnetic energy interacting with that material to appreciably impact the performance of a connector may be regarded as lossy. A meaningful impact results from attenuation over a frequency range of interest for a connector. In some configurations, lossy material may suppress resonances within ground structures of the connector and the frequency range of interest may include the natural frequency of the resonant structure, without the lossy material in place. In other configurations, the frequency range of interest may be all or part of the operating frequency range of the connector.

For testing whether a material is lossy, the material may be tested over a frequency range that may be smaller than or different from the frequency range of interest of the connector in which the material is used. For example, the test frequency range may extend from 10 GHz to 25 GHz or 1 GHz to 5 GHz. Alternatively, lossy material may be identified from measurements made at a single frequency, such as 10 GHz or 15 GHz.

Loss may result from interaction of an electric field component of electromagnetic energy with the material, in which case the material may be termed electrically lossy. Alternatively or additionally, loss may result from interaction of a magnetic field component of the electromagnetic energy with the material, in which case the material may be termed magnetically lossy.

Electrically lossy materials can be formed from lossy dielectric and/or poorly conductive materials. Electrically lossy material can be formed from material traditionally regarded as dielectric materials, such as those that have an electric loss tangent greater than approximately 0.01, greater than 0.05, or between 0.01 and 0.2 in the frequency range of interest. The “electric loss tangent” is the ratio of the imaginary part to the real part of the complex electrical permittivity of the material.

Electrically lossy materials can also be formed from materials that are generally thought of as conductors, but are relatively poor conductors over the frequency range of interest. These materials may conduct, but with some loss, over the frequency range of interest such that the material conducts more poorly than a conductor of an electrical connector, but better than an insulator used in the connector. Such materials may contain conductive particles or regions that are sufficiently dispersed that they do not provide high conductivity or otherwise are prepared with properties that lead to a relatively weak bulk conductivity compared to a good conductor such as pure copper over the frequency range of interest. Die cast metals or poorly conductive metal alloys, for example, may provide sufficient loss in some configurations.

Electrically lossy materials of this type typically have a bulk conductivity of about 1 Siemen/meter to about 100,000 Siemens/meter, or about 1 Siemen/meter to about 30,000 Siemens/meter, or 1 Siemen/meter to about 10,000 Siemens/meter. In some embodiments, material with a bulk conductivity of between about 1 Siemens/meter and about 500 Siemens/meter may be used. As a specific example, material with a conductivity between about 50 Siemens/meter and 300 Siemens/meter may be used. However, it should be appreciated that the conductivity of the material may be selected empirically or through electrical simulation using known simulation tools to determine a conductivity that provides suitable signal integrity (SI) characteristics in a connector. The measured or simulated SI characteristics may be, for example, low cross talk in combination with a low signal path attenuation or insertion loss, or a low insertion loss deviation as a function of frequency.

It should also be appreciated that a lossy member need not have uniform properties over its entire volume. A lossy member, for example, may have an insulative skin or a conductive core, for example. A member may be identified as lossy if its properties on average in the regions that interact with electromagnetic energy sufficiently attenuate the electromagnetic energy.

In some embodiments, lossy material is formed by adding to a binder a filler that contains particles. In such an embodiment, a lossy member may be formed by molding or otherwise shaping the binder with filler into a desired form. The lossy material may be molded over and/or through openings in conductors, which may be ground conductors or shields of the connector. Molding lossy material over or through openings in a conductor may ensure intimate contact between the lossy material and the conductor, which may reduce the possibility that the conductor will support a resonance at a frequency of interest. This intimate contact may, but need not, result in an Ohmic contact between the lossy material and the conductor.

Alternatively or additionally, the lossy material may be molded over or injected into insulative material, or vice versa, such as in a two shot molding operation. The lossy material may press against or be positioned sufficiently near a ground conductor that there is appreciable coupling to a ground conductor. Intimate contact is not a requirement for electrical coupling between lossy material and a conductor, as sufficient electrical coupling, such as capacitive coupling, between a lossy member and a conductor may yield the desired result. For example, in some scenarios, 100 pF of coupling between a lossy member and a ground conductor may provide an appreciable impact on the suppression of resonance in the ground conductor. In other examples with frequencies in the range of approximately 10 GHZ or higher, a reduction in the amount of electromagnetic energy in a conductor may be provided by sufficient capacitive coupling between a lossy material and the conductor with a mutual capacitance of at least about 0.005 pF, such as in a range between about 0.01 pF to about 100 pF, between about 0.01 pF to about 10 pF, or between about 0.01 pF to about 1 pF. To determine whether lossy material is coupled to a conductor, coupling may be measured at a test frequency, such as 15 GHz or over a test range, such as 10 GHz to 25 GHz.

To form an electrically lossy material, the filler may be conductive particles. Examples of conductive particles that may be used as a filler to form an electrically lossy material include carbon or graphite formed as fibers, flakes, nanoparticles, or other types of particles. Various forms of fiber, in woven or non-woven form, coated or non-coated may be used. Non-woven carbon fiber is one suitable material. Metal in the form of powder, flakes, fibers or other particles may also be used to provide suitable electrically lossy properties. Alternatively, combinations of fillers may be used. For example, metal plated carbon particles may be used. Silver and nickel are suitable metal plating for fibers. Coated particles may be used alone or in combination with other fillers, such as carbon flake.

Preferably, the fillers will be present in a sufficient volume percentage to allow conducting paths to be created from particle to particle. For example, when metal fiber is used, the fiber may be present in about 3% to 30% by volume. The amount of filler may impact the conducting properties of the material, and the volume percentage of filler may be lower in this range to provide sufficient loss.

The binder or matrix may be any material that will set, cure, or can otherwise be used to position the filler material. In some embodiments, the binder may be a thermoplastic material traditionally used in the manufacture of electrical connectors to facilitate the molding of the electrically lossy material into the desired shapes and locations as part of the manufacture of the electrical connector. Examples of such materials include liquid crystal polymer (LCP) and nylon. However, many alternative forms of binder materials may be used. Curable materials, such as epoxies, may serve as a binder. Alternatively, materials such as thermosetting resins or adhesives may be used.

While the above-described binder materials may be used to create an electrically lossy material by forming a binder around conducting particle fillers, lossy materials may be formed with other binders or in other ways. In some examples, conducting particles may be impregnated into a formed matrix material or may be coated onto a formed matrix material, such as by applying a conductive coating to a plastic component or a metal component. As used herein, the term “binder” encompasses a material that encapsulates the filler, is impregnated with the filler or otherwise serves as a substrate to hold the filler.

Magnetically lossy material can be formed, for example, from materials traditionally regarded as ferromagnetic materials, such as those that have a magnetic loss tangent greater than approximately 0.05 in the frequency range of interest. The “magnetic loss tangent” is the ratio of the imaginary part to the real part of the complex electrical permeability of the material. Materials with higher loss tangents may also be used.

In some embodiments, a magnetically lossy material may be formed of a binder or matrix material filled with particles that provide that layer with magnetically lossy characteristics. The magnetically lossy particles may be in any convenient form, such as flakes or fibers. Ferrites are common magnetically lossy materials. Materials such as magnesium ferrite, nickel ferrite, lithium ferrite, yttrium garnet or aluminum garnet may be used. Ferrites will generally have a loss tangent above 0.1 at the frequency range of interest. Presently preferred ferrite materials have a loss tangent between approximately 0.1 and 1.0 over the frequency range of 1 GHz to 3 GHZ and more preferably a magnetic loss tangent above 0.5 over that frequency range.

Practical magnetically lossy materials or mixtures containing magnetically lossy materials may also exhibit useful amounts of dielectric loss or conductive loss effects over portions of the frequency range of interest. Suitable materials may be formed by adding fillers that produce magnetic loss to a binder, similar to the way that electrically lossy materials may be formed, as described above.

It is possible that a material may simultaneously be a lossy dielectric or a lossy conductor and a magnetically lossy material. Such materials may be formed, for example, by using magnetically lossy fillers that are partially conductive or by using a combination of magnetically lossy and electrically lossy fillers.

Lossy portions also may be formed in a number of ways. In some examples the binder material, with fillers, may be molded into a desired shape and then set in that shape. In other examples the binder material may be formed into a sheet or other shape, from which a lossy member of a desired shape may be cut. In some embodiments, a lossy portion may be formed by interleaving layers of lossy and conductive material such as metal foil. These layers may be rigidly attached to one another, such as through the use of epoxy or other adhesive, or may be held together in any other suitable way. The layers may be of the desired shape before being secured to one another or may be stamped or otherwise shaped after they are held together. As a further alternative, lossy portions may be formed by plating plastic or other insulative material with a lossy coating, such as a diffuse metal coating.

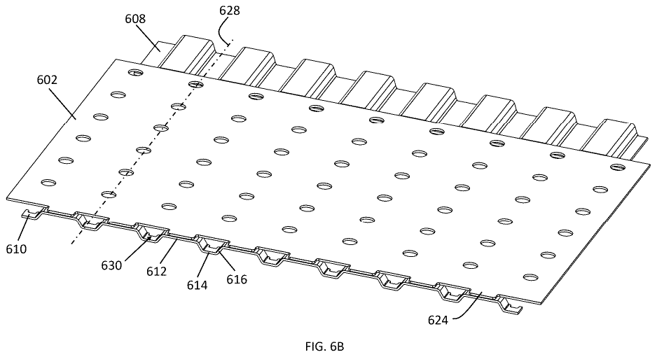

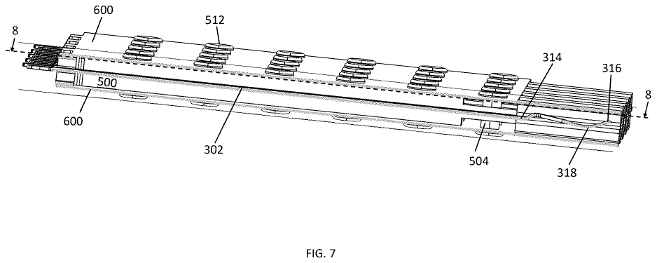

FIGS. 6A and 6B show the shielding member 600, which may be disposed on a side of the lead assembly 200. As illustrated, the shielding member 600 may include a conductive sheet 602 having first and second edges 604 and 606, and first and second corrugated sheets 608 and 610 disposed adjacent the first and second edges 604 and 606 of the conductive sheet 602, respectively.

Each corrugated sheet may include plateaus 612, valleys 614, and bridges 616 each joining an adjacent plateau 612 and valley 614. Edges 622 of the plateaus 612 of the first corrugated sheet 608 may abut the first edge 604 of the conductive sheet 602 such that broadsides 618 of the plateaus 612 of the first corrugated sheet 608 are flush with a broadside 620 of the conductive sheet 602. In some embodiments, edges 622 of the plateaus 612 of the first corrugated sheet 608 may be welded to the first edge 604 of the conductive sheet 602.

The conductive sheet 602 may include tabs 624 extending beyond the second edge 606. The tabs 624 may at least partially overlap with respective plateaus 612 of the second corrugated sheet 610. In some embodiments, the tabs 624 may be welded, for example via laser welding, to the respective plateaus 612 of the second corrugated sheet 610.

The conductive sheet 602 may include groups of holes 626. Each group of holes (e.g., a group of holes 626 aligned in a line marked 628) may be aligned with respective valleys 614 of the first and second corrugated sheets 608 and 610. As described above, the lossy material 500 may extend through the holes 626 to form lossy buttons 512 thereabout and therefore secure the shielding members 600 to the housing 400. FIG. 7 is a cross-sectional perspective view of the lead assembly 200 along a line marked “7-7” in FIG. 2A, with the housing 400 hidden and showing the lossy material 500 connecting the top and bottom shielding members 600.

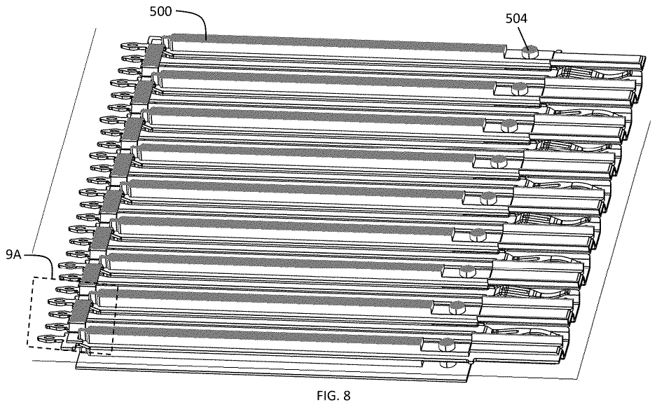

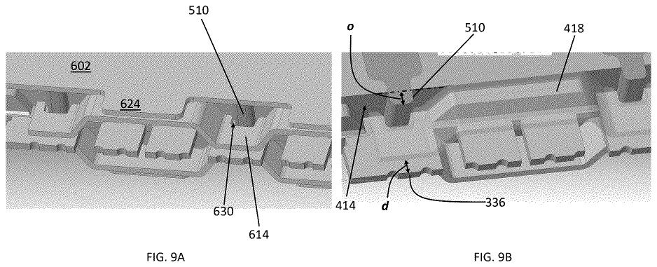

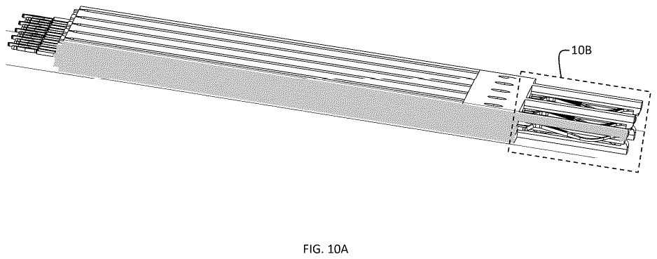

The inventors have recognized and appreciated that having lossy material overlapping with the corrugated sheets may reduce crosstalk and therefore improve signal integrity. In some embodiments, as shown in FIG. 6B, the valleys 614 of the second corrugated sheet 610 may include recesses 630 configured to have at least a portion of ends 510 of the lossy portions 502 extend therethrough. FIG. 8 is a cross-sectional perspective view of the lead assembly 200 along a line marked “8-8” in FIG. 7, with the housing 400 hidden. FIG. 9A is an enlarged perspective view of a region of the lead assembly of FIG. 2A in a box marked “9A” in FIG. 8, with portions of the beams 332 hidden. FIG. 9B is another perspective view of the region 9A, with a top corrugated sheet 610 of the shielding member 600 shown in phantom and a corresponding top conductive sheet 602 hidden. As illustrated, at least a portion of the ends 510 of the lossy material 500 may extend beyond the second edge 414 of the housing 400 by a distance o (e.g., in a range of 0.1 mm to 0.3 mm such as 0.2 mm) and into the recesses 630 of the valleys 614 of the second corrugated sheets 610 of the top and bottom shielding members 600.

The valleys 614 of the second corrugated sheets 610 of the top and bottom shielding members 600 may contact the tail segments of the ground conductors. The second corrugated sheets 610 may extend beyond the second edge 414 of the housing 400 and spaced from the board stop 336 by a distance d (e.g., in a range of 0.05 mm to 0.2 mm such as 0.15 mm) so as to extend the enclosing structure close to the surface of a circuit board that the connector may mount to and therefore reduce crosstalk in the board termination region.

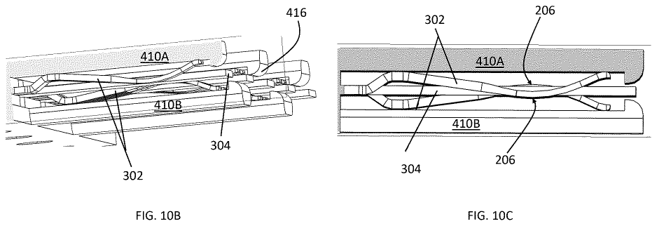

The inventors have also recognized and appreciated design techniques at the front segments that reduce resonance and improve signal integrity. For example, as described above, signal conductors may be disposed in alternating pairs. FIG. 10A is a cross-sectional perspective view of the lead assembly 200 along the line marked “8-8” in FIG. 7, with the lossy material 500 and the shielding member 600 hidden. FIG. 10B is an enlarged view of a region of the lead assembly of FIG. 10A in a box marked “10B” in FIG. 10A. FIG. 10C is a side view of the region 10B.

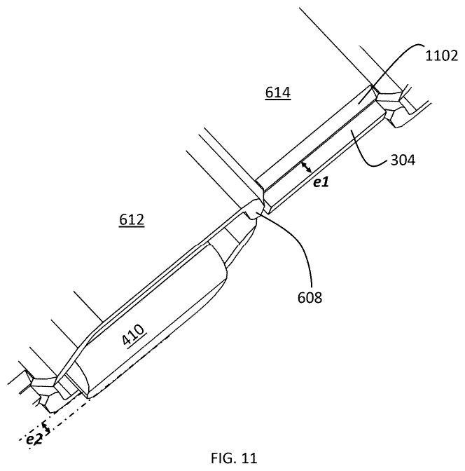

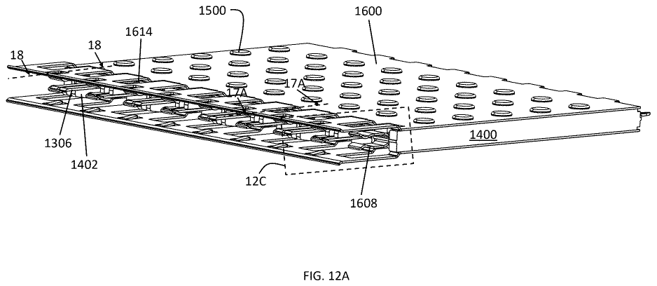

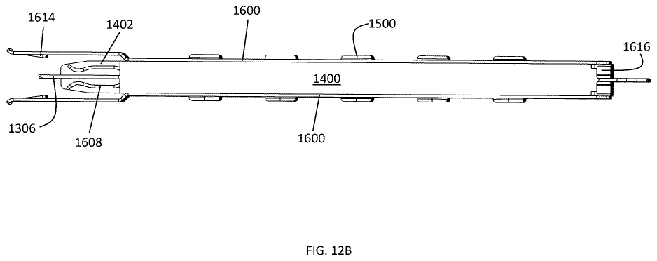

As another example, the plateaus of the corrugated sheet at the front segments may extend beyond respective valleys. FIG. 11 is a perspective view of a region of the lead assembly 200 in a box marked “11” in FIG. 2A. As illustrated, the plateaus 612 of the first corrugated sheet 608 may extend beyond the valleys 614 in a mating direction. The front segments 306 of the ground conductors 304 may extend beyond respective valleys 614 in the mating direction by a distance e1, which may be in a range of 0.05 mm to 0.15 mm such as 0.1 mm. The valleys 614 may comprise chamfers 1102 offset from the ground conductors 304 in the mating direction. The plateaus 612 may be flush with the front segments 306 of the ground conductors 304 in a plane perpendicular to the mating direction. The extensions 410 of the housing 400 may extend beyond the plateaus 612 in the mating direction by a second distance e2, which may be in a range of 0.05 mm to 0.15 mm such as 0.1 mm. Such a configuration may enable the extensions 410 to provide a hard stop for a mating connector. The inventors have recognized and appreciated that the setbacks (e.g., e1, e2) and chamfers (e.g., 1102), individually and/or in combination, may reduce crosstalk in the mating interface.

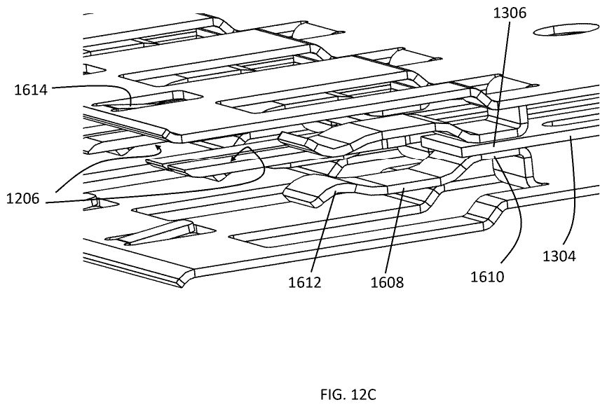

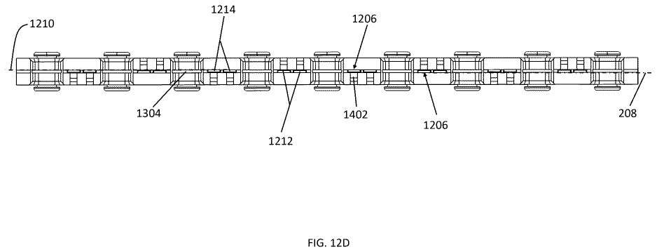

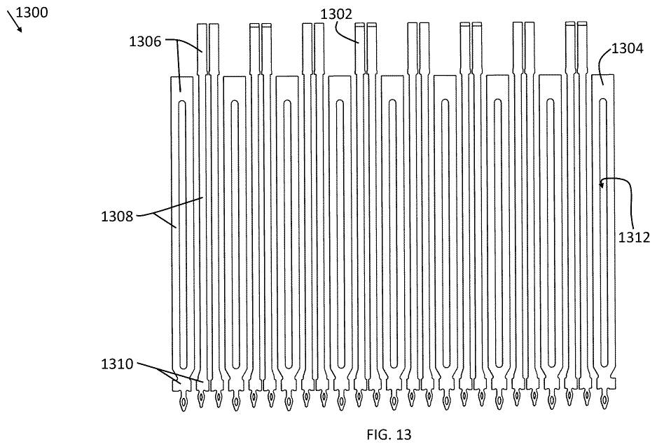

FIGS. 12A and 12B show a lead assembly 1200 of the header connector 112 of the electrical interconnection system 100, according to some embodiments. FIG. 12C is an enlarged perspective view of a region of the lead assembly 1200 in a box marked “12C” in FIG. 12A. FIG. 12D is a front view of the lead assembly 1200, with shielding members 1600 hidden. It should be appreciated that the lead assembly 1200 of the header connector 112 may share one or more features of the lead assembly 200 of the receptacle connector 102, which may or may not be repeated in the following descriptions.

As illustrated, the lead assembly 1200 may include conductive elements 1300, a housing 1400 at least partially holding the conductive elements 1300, shielding members 1600 disposed on opposite sides of the conductive elements 1300, and lossy material 1500 configured to secure the shielding members 1600 in desired positions. In some embodiments, the shielding members 1600 may be symmetrical about the conductive elements 1300.

FIG. 13 shows the conductive elements 1300 of the lead assembly 1200, with other portions of the lead assembly 1300 hidden for simplicity of illustration. The conductive elements 1300 may include signal conductors 1302 and ground conductors 1304 disposed between adjacent signal conductors 1302. Each conductive element may include a front segment 1306, a tail segment 1310, and an intermediate portion 1308 between the front segment 1306 and tail segment 1310.

As illustrated, the front segments 1306 of the signal conductors 1302 may extend beyond the front segments 1306 of the ground conductors 1304 in a mating direction. The front segments 1306 of both the signal conductors 1302 and the ground conductors 1304 may include blades. The ground conductors 304 may be wider than the signal conductors 302 in a direction perpendicular to the mating direction. Each ground conductor 1304 may include a slot 1312 elongated along the intermediate portion 1308 of the ground conductor 1304. In some embodiments, the slot may extend along 60% to 100% of a length of the intermediate portion 1308 of the ground conductor 1304.

In some embodiments, signal conductors may be disposed in alternating pairs, with adjacent first and second pairs 1212 and 1214 having mating contact surfaces facing opposite sides of the lead assembly 1200. For example, as illustrated in FIG. 12D, the mating contact surfaces 1206 of the first pairs 1212 may be aligned in a first plane 1208; and the mating contact surfaces 1206 of the second pairs 1214 may be aligned in a second plane 1210 parallel to the first plane 1208. The inventors have recognized and appreciated that such a configuration may generate more balanced mating forces than a conventional design with all mating contact surfaces facing a same side, enabling disposing the pairs close to each other to achieve desired high density.

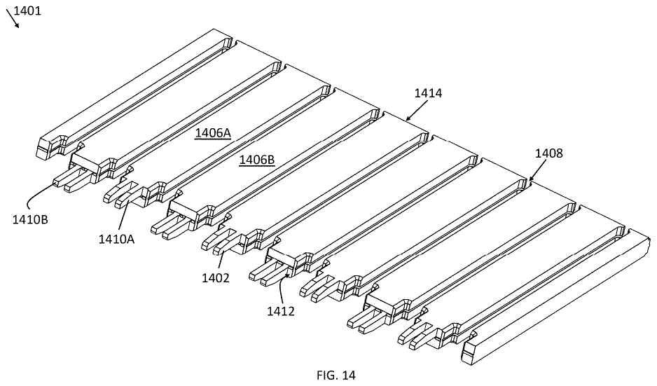

FIG. 14 shows insulative portions 1401 of the housing of the lead assembly 1200. For simplicity of illustration, other portions of the lead assembly, including conductive elements 1300, are hidden in this view to reveal exemplary structural features of a lead assembly housing, such as extensions 1402. Extensions 1402 may align with front segments 1306, for example, to support front segments 1306 during mating. In some examples, however, housing 1400 may be molded over conductive elements, such as conductive elements 1300 to hold the conductive elements in a lead assembly.

As illustrated, the housing 1400 may include a first edge 1412 and a second edge 1414. The front segments 1306 of the conductive elements 1300 may extend out of the first edge 1412, and the tail segments 1310 of the conductive elements 1300 may extend out of the second edge 1414.

The housing 1400 may include a body at least partially enclosing the intermediate portions 1308 of the conductive elements 1300. The body may include first housing portions 1406A and second housing portions 1406B disposed in alternative and with gaps 1408 therebetween. Each housing portion 1406A or 1406B may at least partially enclose the intermediate portions 1308 of one or more signal conductors 1302 (e.g., a signal pair) and include first or second extensions 1410A, 1010B configured to support the first or second pairs 1214, 1216 from a side opposite the mating contact surfaces 1206 of the first or second pairs 1214, 1216.

The housing 1400 may be made of an insulative material, which may be a dielectric material such as plastic or nylon. Examples of suitable materials include, but are not limited to, liquid crystal polymer (LCP), polyphenylene sulfide (PPS), high temperature nylon or polyphenylene oxide (PPO) or polypropylene (PP). Other suitable materials may be employed, as aspects of the present disclosure are not limited in this regard.

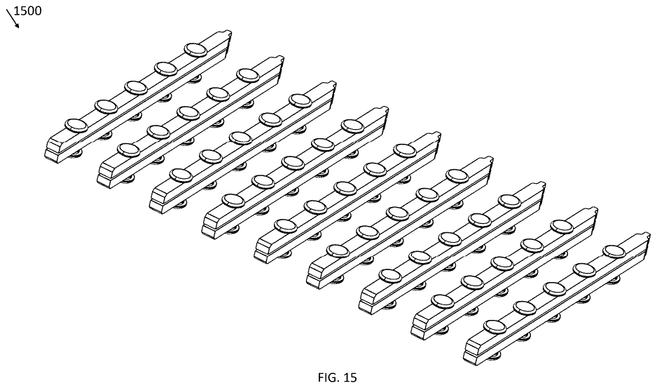

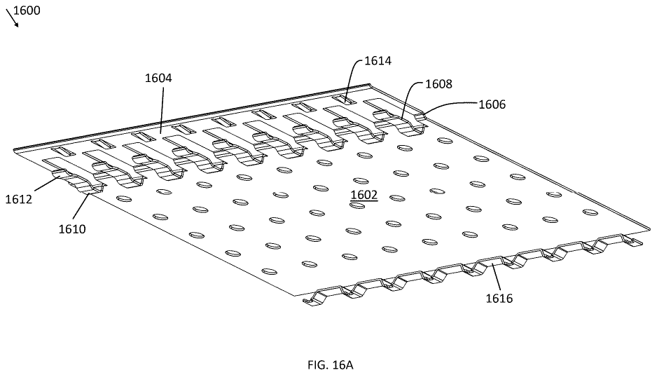

FIG. 15 shows the lossy material 1500 of the lead assembly 1200. For simplicity of illustration, other portions of the lead assembly, including conductive elements 1300, insulative portions 1401 of the housing, and shielding member 1600, are hidden in this view to reveal exemplary structural features of the lossy material. In this example, lossy material 1500 is shown with buttons such as may be formed by flattening pillars of lossy material against a shielding member (e.g., shielding member 1600) placed against a surface of the lead assembly housing.

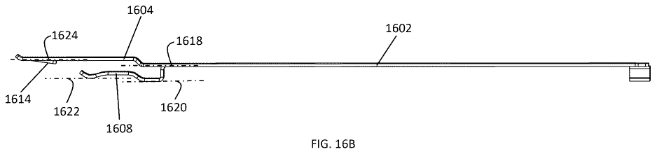

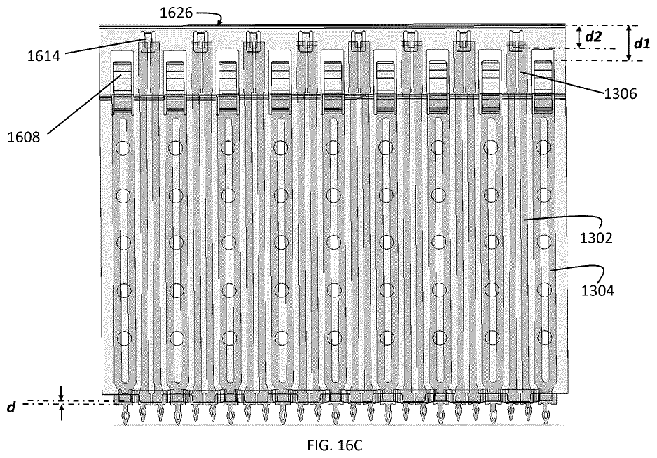

FIGS. 16A and 16B show a shielding member 1600 of the lead assembly 1200. FIG. 16C is a top view of the shielding member 1600 shown in phantom, showing the conductive elements 1300. The shielding member 1600 may include a first sheet 1602 extending in a first plane 1618, and first beams 1608 extending from the first sheet 1602.

Each first beam 1608 may jog away from the first plane 1618 to a second plane 1620 and then jog away from the second plane 1620 to a third plane 1622 disposed between the first plane 1618 and second plane 1620. Each first beam 1608 may have a first contact portion 1610 attached to the front segment 1306 of a respective ground conductor 1304 and a second contact portion 1612 configured to make contact with a valley of a corrugated sheet that attached to a ground conductor of a mating connector (e.g., valley 614 of corrugated sheet 608 of the shielding member 600 of the lead assembly 200 of the receptacle connector 102).

The shielding member 1600 may include a second sheet 1604 extending in a fourth plane 1624 separated from the third plane 1622 by the first plane 1618, and second beams 1614 extending from the second sheet 1604. The first and second sheets 1602 and 1604 may be integral with each other. In the illustrated example, the first and second sheets 1602 and 1604 are connected by a jog 1606. The second beams may be configured to make contact with plateaus of corrugated sheets of a mating connector (e.g., plateaus 612 of corrugated sheet 608 of the shielding member 600 of the lead assembly 200 of the receptacle connector 102).

The inventor have recognized and appreciated that the beams may be simply stamped out of the outer shields, enabling economical manufacturing.

As illustrated in FIG. 16A, the shielding member 1600 may include a corrugated sheet 1616 coupled to the second sheet 1604 through the first sheet 1602. The corrugated sheet 1616 comprises plateaus connected to the first sheet 1602, valleys disposed between adjacent plateaus, and bridges joining adjacent plateau and valley.

As illustrated in FIG. 16C, the shielding member 1600 may have a distal edge 1626. The first beams 1608 may extend from the shielding member 1600 at a first distance d1 from the distal edge 1626. The first beams 1608 may extend towards the distal edge 1626. The second beams 1614 may extend from the shielding member 1600 at a second distance d2 from the distal edge 1626. The first distance d1 may be greater than the second distance d2.

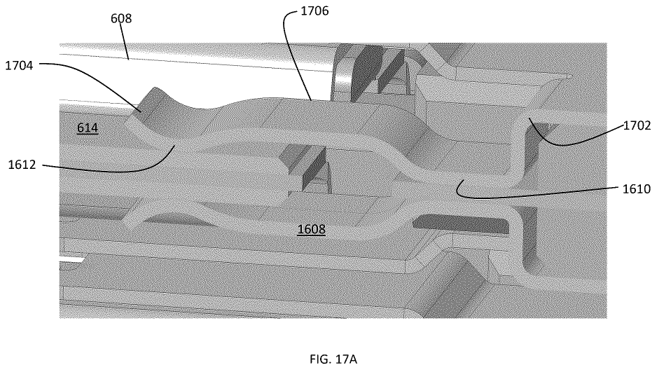

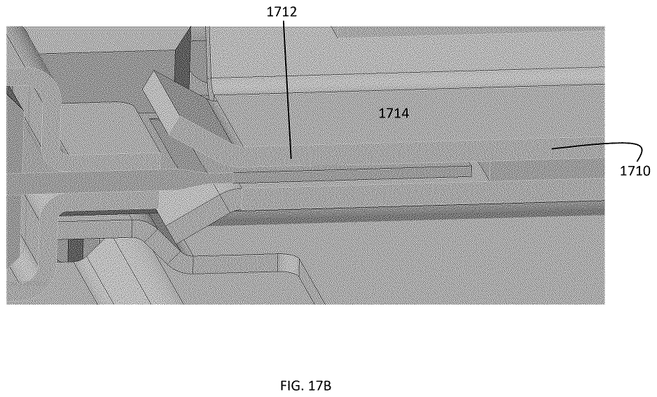

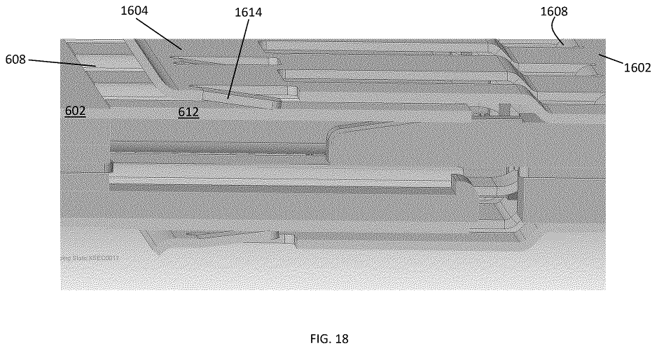

The inventor have recognized and appreciated that such a configuration may enable a sequential mating. FIG. 17A is an enlarged cross-sectional perspective view of the lead assembly of FIG. 12A along a line marked “17A-17A” in FIG. 12A, showing portions of a mating connector (e.g., connector 102). As illustrated, each first beam 1608 may comprise a first contact portion 1610 at a proximal end 1702, a second contact portion 1612 adjacent a distal end 1704, and a curved portion 1706 joining the first contact portion 1610 and second contact portion 1612. FIG. 18 is an enlarged cross-sectional view of a region of the lead assembly 1200 along a line marked “18-18” in FIG. 12A, showing portions of a mating connector.

During connector mating, the second beams 1614 may first make contact with the plateaus of the corrugated sheets of the mating connector, which can reduce the risk of damages from electrostatic discharge (ESD). Next, the signal conductors of the mating conductors may mate with each other. Lastly, the first beams 1608 may make contact with the valleys of the corrugated sheets of the mating connector. Such a sequential mating may reduce mating forces, while reducing the risk of damages from ESD.

FIG. 17B is a perspective view of a mating region between lead assemblies of mating connectors as shown in FIG. 17A, according to an alternative embodiment. As illustrated, a first connector (e.g., a receptacle connector) may have valleys 1714 of corrugated sheets both attached to ground conductors of the first connector at first contact portions 1710 and forming a slot configured to receive a ground conductor of a second connector (e.g., a header connector) at second contact portions 1712. The inventors have recognized and appreciated that the configuration may disrupt a ground loop and improve signal integrity.

The inventors have also recognized and appreciated techniques to reduce resonances and increase the integrity of signals passing through a connector that are attached with cables. The techniques may include connecting shields of connector subassemblies to shields of cables that are attached to the connector subassemblies. The connection may be made through a shielding member at cable attachment regions. The shielding member may include chambers each for the cable attachment region of a signal pair. Each chamber may have a first profile at a first end abutting a rear end of a lead assembly and a second profile at a second end configured for cables to extend thereout. The first profile may mimic the profile provided by corrugated sheets so as to reduce pair-to-pair crosstalk and match impedance control of connectors using corrugated sheets. The second profile may conform to an outer profile of a cable shield so as to contact the cable shield.

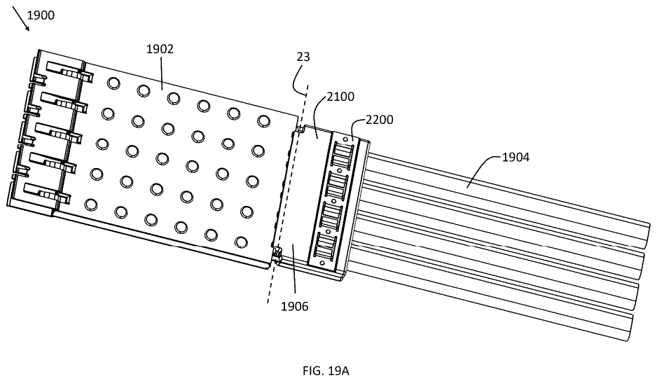

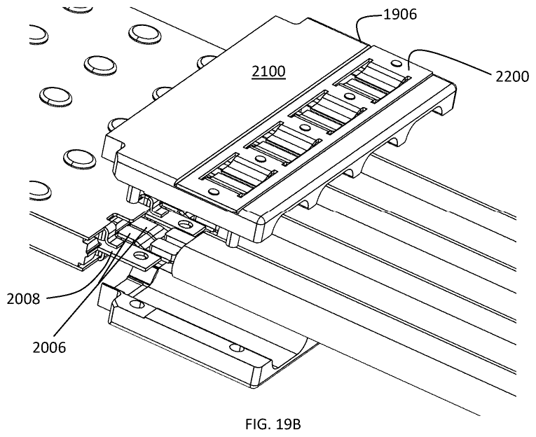

FIG. 19A shows a cable assembly 1900, according to some embodiments. The cable assembly 1900 may include a lead assembly 1902, cables 1904, and a shielding member 1906 for a cable attachment region. As illustrated, the lead assembly 1902 of the cable assembly 1900 may share one or more features of the lead assembly 1200 of the header connector 112, which may or may not be repeated in the following descriptions. It should be appreciated that although the lead assembly 1902 is illustrated to have features of the lead assembly 1200 of the header connector 112, a lead assembly of a cable assembly may share one or more features of the lead assembly 200 of the receptacle connector 102. For example, a cable assembly may be configured as a receptacle cable assembly for mating with a header cable assembly.

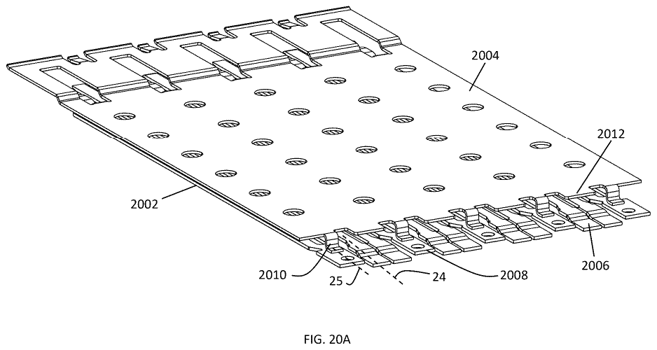

FIG. 19B is a partially exploded view of the cable assembly 1900, with a front portion of a lead assembly cut off to enlarge the cable attachment region. FIG. 20A is a top, rear perspective view of the lead assembly 1902, with portions hidden to show conductive elements 2002 and a shielding member 2004. FIG. 20B is a side view of the lead assembly 1902 as shown in FIG. 20A.

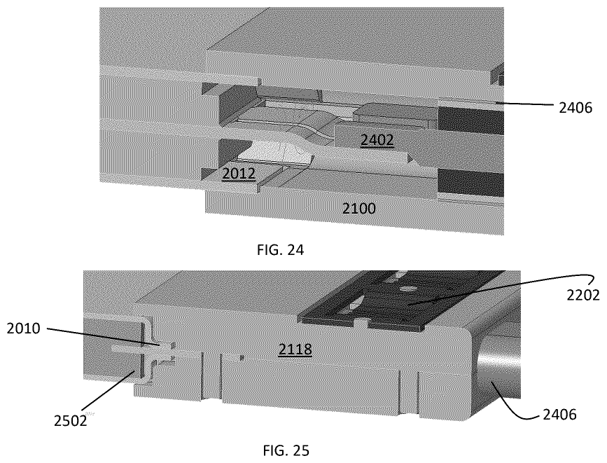

As illustrated, the conductive elements 2002 may include signal conductors 2006 and ground conductors 2008. Tail segments of the signal conductors 2006 may be configured for cable attachment. Tail segments of the signal conductors 2006 may jog down such that cable wires 2402 attached to the tails may be substantially on a plane with the conductive elements, as shown in FIG. 24, which is a partial cross-sectional perspective view of the cable assembly 1900 along a line marked “24” in FIG. 20A.

The shielding member 2004 may include tabs 2012 extending beyond a rear edge and overlapping with the tail segments of the signal conductors 2006. The shielding member 2004 may include contact portions 2010 disposed between the tabs 2012 and contacting tail segments of the ground conductors 2008.

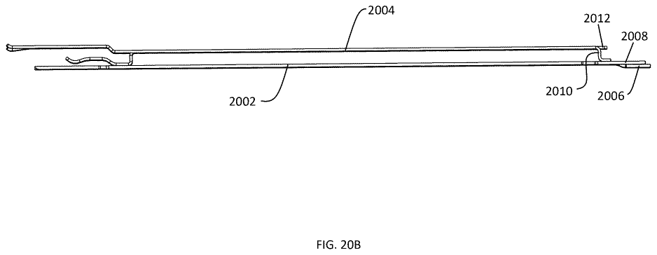

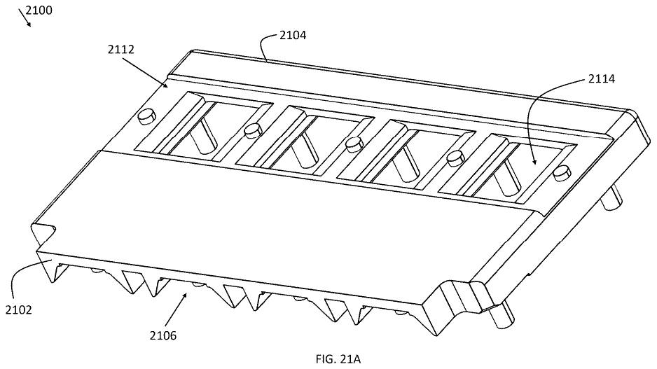

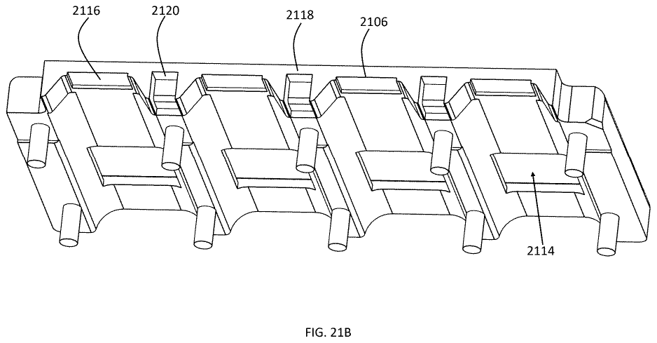

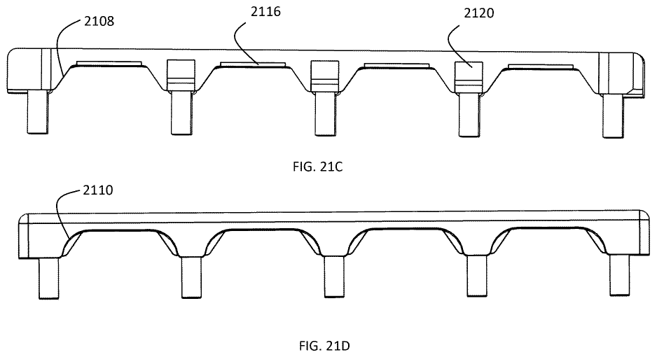

The shielding member 1906 may include a hooding portion 2100 and a compliant portion 2200. FIGS. 21A and 21B show the hooding portion 2100. FIG. 21C is a front view of the hooding portion 2100. FIG. 21D is a rear view of the hooding portion 2100. The hooding portion 2100 may include a first end 2102 configured to abut a rear end of lead assembly 1902, a second end 2104 configured for cables 1904 to extend thereout, and chambers 2106.

Each chamber 2106 may extend from the first end 2102 to the second end 2104. Each chamber may having a first profile 2108 at the first end 2102 and a second profile 2110 at the second end 2104. The second profile 2110 may conform to an outer profile of a cable shield 2406 of a cable 1904 so as to contact the cable shield 2406, as shown in FIG. 25, which is a partial cross-sectional perspective view of the cable assembly 1900 along a line marked “25” in FIG. 20A.

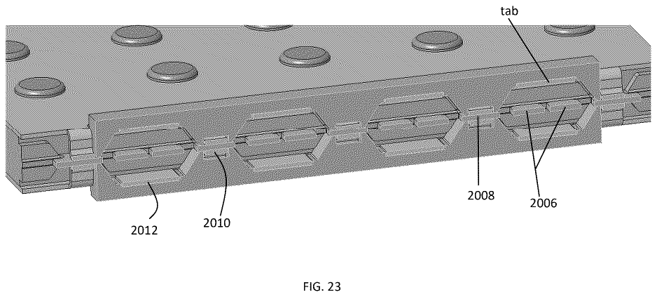

The first profile 2108 may be different from the second profile 2110. FIG. 23 is a cross-sectional perspective view of the cable assembly 1900 along a line marked “23” in FIG. 19A. As illustrated, the first profile may mimic the profile provided by corrugated sheets. The inventors have recognized and appreciated that such profiles may reduce pair-to-pair crosstalk and match impedance control of connectors using corrugated sheets.

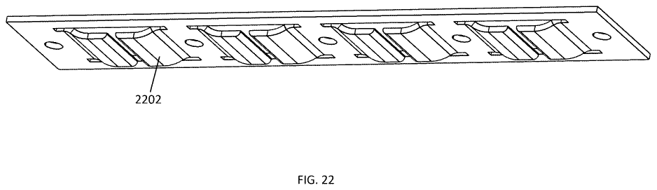

Referring back to FIG. 21A, the chambers 2106 may be on an inner side of the shielding member 1906. The shielding member 1906 may include a recess 2112 on an outer side. The compliant portion 2200 may be disposed in the recess 2112. The hooding portion 2100 may include opening 2114 extending through the outer side to the inner side. The compliant portion 2200 may include compliant beams 2202 (FIG. 22). The compliant beams 2202 may extend through respective openings 2114 into respective chambers 2106 so as to contact the cables shields disposed inside the respective chambers.

As shown in FIG. 21B, each chamber 2106 may include a first groove 2116 shaped and positioned to receive the tab 2012 of the shielding member. The hooding portion 2100 may include separators 2118 between adjacent chambers. Each separator 2118 may include a second groove 2120 shaped and positioned to receive the contact portion 2010 of the shielding member 2004. For example, FIG. 23 shows tabs 2012 disposed in the first grooves 2116 and contact portions 2010 disposed in the second grooves 2120.

Like lead assemblies 200 and 1200, the lead assembly 1902 may include a lossy material. As illustrated in FIG. 25, ends 2502 of lossy portions of the lossy material may extend adjacent to the contact portions 2010 of the shielding member 2004 and into respective second grooves 2120. The inventors have recognized and appreciated that such configuration, though over a small distance (e.g., in a range of 0.1 mm to 0.3 mm such as 0.2 mm), may reduce crosstalk and therefore improve signal integrity.

Although details of specific configurations of conductive elements, housings, and shield members are described above, it should be appreciated that such details are provided solely for purposes of illustration, as the concepts disclosed herein are capable of other manners of implementation. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art. Such alterations, modifications, and improvements are intended to be within the spirit and scope of the invention. Accordingly, the foregoing description and drawings are by way of example only.

Various changes may be made to the illustrative structures shown and described herein. As a specific example of a possible variation, the connector may be configured for a frequency range of interest, which may depend on the operating parameters of the system in which such a connector is used, but may generally have an upper limit between about 15 GHz and 224 GHz, such as 25 GHz, 30 GHz, 40 GHz, 56 GHz, 112 GHz, or 224 GHZ, although higher frequencies or lower frequencies may be of interest in some applications. Some connector designs may have frequency ranges of interest that span only a portion of this range, such as 1 to 10 GHz or 5 to 35 GHz or 56 to 112 GHZ.

The operating frequency range for an interconnection system may be determined based on the range of frequencies that can pass through the interconnection with acceptable signal integrity. Signal integrity may be measured in terms of a number of criteria that depend on the application for which an interconnection system is designed. Some of these criteria may relate to the propagation of the signal along a single-ended signal path, a differential signal path, a hollow waveguide, or any other type of signal path. Two examples of such criteria are the attenuation of a signal along a signal path or the reflection of a signal from a signal path.

Other criteria may relate to interaction of multiple distinct signal paths. Such criteria may include, for example, near end cross talk, defined as the portion of a signal injected on one signal path at one end of the interconnection system that is measurable at any other signal path on the same end of the interconnection system. Another such criterion may be far end cross talk, defined as the portion of a signal injected on one signal path at one end of the interconnection system that is measurable at any other signal path on the other end of the interconnection system.

As specific examples, it could be required that signal path attenuation be no more than 3 dB power loss, reflected power ratio be no greater than −20 dB, and individual signal path to signal path crosstalk contributions be no greater than −50 dB. Because these characteristics are frequency dependent, the operating range of an interconnection system is defined as the range of frequencies over which the specified criteria are met.

Designs of an electrical connector are described herein that improve signal integrity for high frequency signals, such as at frequencies in the GHz range, including up to about 25 GHz or up to about 40 GHz, up to about 56 GHz or up to about 60 GHz or up to about 75 GHz or up to about 112 GHz or higher, while maintaining high density, such as with a spacing between adjacent mating contacts on the order of 3 mm or less, including center-to-center spacing between adjacent contacts in a column of between 1 mm and 2.5 mm or between 2 mm and 2.5 mm, for example. Spacing between columns of mating contact portions may be similar, although there is no requirement that the spacing between all mating contacts in a connector be the same.

Manufacturing techniques may also be varied. Connector manufacturing techniques were described using specific connector configurations as examples. The techniques described herein for forming mating and mounting interfaces of connectors are applicable to connectors in other configurations, such as backplane connectors, cable connectors, stacking connectors, mezzanine connectors, I/O connectors, chip sockets, etc.

In some embodiments, contact tails were illustrated as press fit “eye of the needle” compliant sections that are designed to fit within vias of printed circuit boards. However, other configurations may also be used, such as surface mount elements, solderable pins, etc., as aspects of the present disclosure are not limited to the use of any particular mechanism for attaching connectors to printed circuit boards.

Further, connector features were described, for simplicity of explanation, as upward or downward. Such orientations need not be referenced to gravity or other fixed coordinate system and may indicate relative position or orientation. In some scenarios, upward or downward may be relative to a mounting face of the connector, configured for mounting against a printed circuit board. Similarly, terms such as horizontal or vertical may define relative orientation and, in some scenarios, may indicate orientation relative to a face of the connector configure for mounting against a printed circuit board. Likewise, some connector features were described as forward, or front, or the like. Other connector features were described as rearward, or back, or the like. These terms too, are relative terms, not fixed to any orientation in a fixed coordinate system. In some scenarios, these terms may be relative to a mating face of the connector, with the mating face being at the front of the connector.

The present disclosure is not limited to the details of construction or the arrangements of components set forth in the foregoing description and/or the drawings. Various embodiments are provided solely for purposes of illustration, and the concepts described herein are capable of being practiced or carried out in other ways. Also, the phraseology and terminology used herein are for the purpose of description and should not be regarded as limiting. The use of “including,” “comprising,” “having,” “containing,” or “involving,” and variations thereof herein, is meant to encompass the items listed thereafter (or equivalents thereof) and/or as additional items.

What is claimed is:

1. A subassembly for an electrical connector, comprising:
a housing;
a plurality of conductive elements held by the housing, each of the plurality of conductive elements comprising a front segment extending out of a first edge of the housing, a tail segment extending out of a second edge of the housing and configured to mount to a circuit board, and an intermediate portion between the front segment and the tail segment; and
first and second corrugated sheets disposed on opposite sides of the tail segments of the plurality of conductive elements, each of the first and second corrugated sheets comprising a plurality of valleys overlapping with the tail segments of selected conductive elements of the plurality of conductive elements, a plurality of plateaus each disposed between adjacent valleys of the plurality of valleys, and a plurality of bridges each connecting an adjacent plateau and valley.

2. The subassembly of claim 1, comprising:
first and second conductive sheets disposed on opposite sides of the housing and comprising tabs extending beyond the second edges of the housing, wherein:
the tabs of the first conductive sheet at least partially overlaps with respective plateaus of the plurality of plateaus of the first corrugated sheet; and
the tabs of the second conductive sheet at least partially overlaps with respective plateaus of the plurality of plateaus of the second corrugated sheet.

3. The subassembly of claim 1, comprising:
a plurality of lossy portions, each lossy portion extending through the tail segment of a respective selected conductive element and valleys of the first and second corrugated sheets overlapping with the tail segment of the respective selected conductive element.

4. The subassembly of claim 3, wherein:
the selected conductive elements of the plurality of conductive elements comprise slots extending along the intermediate portions of the selected conductive elements, ends of the slots extending into the tail segments of the selected conductive elements;
a lossy portion of the plurality of lossy portions extends in the slot of the respective selected conductive element; and
the valleys of the first and second corrugated sheets overlapping with the tail segment of the respective selected conductive element comprise recesses that receive the end of the lossy portion.

5. The subassembly of claim 1, wherein:
the housing comprises a plurality of protrusions extending from the second edge and into spaces between the plateaus of the first and second corrugated sheets and the tail segments of the plurality of conductive elements, each protrusion having a profile conforming to a plateau and bridges connecting the plateau to respective valleys.

6. The subassembly of claim 5, wherein:
the profile is an isosceles trapezoid.

7. The subassembly of claim 1, wherein:
the plurality of valleys of the first and second corrugated sheets are welded to the tail segments of the selected conductive elements of the plurality of conductive elements.

8. The subassembly of claim 2, wherein:
the tabs of the first conductive sheet are welded to the respective plateaus of the plurality of plateaus of the first corrugated sheet; and
the tabs of the second conductive sheet are welded to the respective plateaus of the plurality of plateaus of the second corrugated sheet.

9. An electrical connector configured for mounting to a circuit board when pressed in a mounting direction towards the circuit board, the electrical connector comprising:
a plurality of conductive elements, each of the plurality of conductive elements comprising a front segment, a tail segment, and an intermediate portion between the front segment and the tail segment, wherein:
the tail segment of each of the plurality of conductive elements comprises a shaft and at least one beam extending from an edge of the shaft,
the at least one beam is configured to press against a wall of a via in the circuit board when the electrical connector is mounted to the circuit board with the edge of the shaft facing the circuit board in the mounting direction, and
the edge of the shaft has a profile with a first portion and a second portion, the at least one beam extending from the first portion, and the second portion of the edge extending further in the mounting direction than the first portion.

10. The electrical connector of claim 9, wherein:
the first portion of the profile of the edge of the shaft curves in a direction opposite to the mounting direction.

11. The electrical connector of claim 9, comprising:
a corrugated sheet disposed on a side of the tail segments of the plurality of conductive elements, the corrugated sheets comprising a plurality of valleys overlapping with the tail segments of selected conductive elements of the plurality of conductive elements, a plurality of plateaus each disposed between adjacent valleys of the plurality of valleys, and a plurality of bridges each connecting an adjacent plateau and valley,
wherein an edge of the corrugated sheet is spaced from the edges of the shafts of the tail segments by a distance in a range of 0.05 mm to 0.15 mm.

12. The electrical connector of claim 11, comprising:
a conductive sheet comprising a plurality of tabs each overlapping a respective plateau of the plurality of plateaus of the corrugated sheet.

13. A subassembly for an electrical connector, comprising:
a housing; and
a plurality of conductive elements held by the housing, each of the plurality of conductive elements comprising a front segment comprising a mating contact surface, a tail segment, and an intermediate portion between the front segment and the tail segment, the plurality of conductive elements comprising first conductive elements and second conductive elements, wherein:
the mating contact surfaces of the first conductive elements and the mating contact surfaces of the second conductive elements face opposite directions such that complementary conductive elements of a mating connector make contact with the first conductive elements and second conductive elements from opposite sides; and
the housing comprises a plurality of extensions adjacent respective first conductive elements and second conductive elements, with the extensions on sides of the respective first conductive elements and second conductive elements opposite the mating contact surfaces.

14. The subassembly of claim 13, wherein:
the mating contact surfaces of the first conductive elements are aligned in a first plane; and
the mating contact surfaces of the second conductive elements are aligned in a second plane parallel to the first plane.

15. The subassembly of claim 13, wherein:
the first conductive elements are disposed in pairs; and
the second conductive elements are disposed in pairs and between adjacent pairs of first conductive elements.

16. The subassembly of claim 15, wherein:
the plurality of conductive elements are a plurality of first-type conductive elements; and
the subassembly comprises a plurality of second-type conductive elements disposed between an adjacent pair of first conductive elements and pair of second conductive elements of the first-type.

17. The subassembly of claim 16, wherein:
the plurality of first-type conductive elements extend beyond the plurality of second-type conductive elements in a mating direction; and
the subassembly comprises a shielding member contacting the plurality of second-type conductive elements and configured to make contact with a complementary shielding member of a mating connector.

18. The subassembly of claim 13, wherein:
the housing comprises a body at least partially enclosing the intermediate portions of the plurality of conductive elements; and
the plurality of extensions comprise a plurality of first extensions extending from an edge of the body and configured to support the first conductive elements, and a plurality of second extensions extending from the edge of the body and configured to support the second conductive elements.

19. The subassembly of claim 18, wherein:
the plurality of first extensions of the housing are disposed opposite to the mating contact surfaces of the first conductive elements; and
the plurality of second extensions of the housing are disposed opposite to the mating contact surfaces of the second conductive elements.

20. The subassembly of claim 19, wherein:
the first and second extensions of the housing are disposed in alternative.
